(19) United States
(12) Patent Application Publication
(10) Pub. No.: US 2025/0310529 A1
(43) Pub. Date: Oct. 2, 2025

(54) GROUP CONTEX ENTROPY CODING

(71) Applicant: TENCENT AMERICA LLC, Palo Alto, CA (US)

(72) Inventors: Thuong NGUYEN CANH, Palo Alto, CA (US); Chao HUANG, Palo Alto, CA (US); Pranav KADAM, Palo Alto, CA (US); Xiaozhong XU, Palo Alto, CA (US); Shan LIU, San Jose, CA (US); Ting-Lan LIN, Palo Alto, CA (US)

(73) Assignee: TENCENT AMERICA LLC, Palo Alto, CA (US)

(21) Appl. No.: 19/059,558

(22) Filed: Feb. 21, 2025

Related U.S. Application Data
(60) Provisional application No. 63/570,213, filed on Mar. 26, 2024.
(60) Provisional application No. 63/668,280, filed on Jul. 7, 2024.

(51) Int. Cl. H04N 19/13; G06T 9/00; H04N 19/70; H04N 19/91

(52) U.S. Cl. CPC H04N 19/13; G06T 9/001; H04N 19/70; H04N 19/91

(57) ABSTRACT

A method of encoding performed by at least one processor including generating a set of N coefficients for a polygon mesh; splitting the set of N coefficients into K coefficient groups, each coefficient group from the K coefficient groups associated with an entropy coding strategy based on one or more properties of the polygon mesh; performing, to generate a set of encoded coefficients, entropy encoding on each coefficient group from the K coefficient groups in accordance with a respective entropy coding strategy; and generating a video bitstream including the set of encoded coefficients, in which N and K are positive integers.

### CROSS-REFERENCE TO RELATED APPLICATION

This application claims priority from U.S. Provisional Application No. 63/570,213, filed on Mar. 26, 2024 and U.S. Provisional Application No. 63/668,280, filed on Jul. 7, 2024, the disclosures of each of which are incorporated herein by reference in their entirety.

### FIELD

This disclosure is directed to a set of advanced video coding technologies. More specifically, the present disclosure is directed to group context entropy encoding and probability initialization of entropy encoding.

### BACKGROUND

Entropy coding is a pivotal process in data compression including polygonal mesh compression (PMC). The method encodes input residuals by considering their significant bit, sign, and magnitude. The encoding process is designed to deal with residuals that are greater than one and two. Values that fall within the range of two and a pre-established maximum for arithmetic coding, referred to as ‘maxAC’, are encoded binary-wise with an adaptive context for each bit. It is currently set to 6 bits for both position and attribute residual context. Values that exceed the ‘maxAC’ are handled using exponential Golomb coding.

Notable among contexts are the significant, sign, greater than one, greater than two, and exponential Golomb contexts. When addressing lossless geometry entropy coding in 3D mesh, integer residuals are encoded by leveraging context adaptivity correlated with specific prediction modes. Typically, each coefficient is processed through the entropy encoder, with the adaptive contexts being updated in concurrence with the encoding progression.

There exists a need for more efficient entropy coding mechanisms, particularly by reducing the entropy of the input coefficients. Furthermore, the scope of adaptive contexts available for entropy coding is currently constricted, which may limit encoding optimization.

### SUMMARY

According to one or more embodiments, a method of encoding performed by at least one processor includes generating a set of N coefficients for a polygon mesh; splitting the set of N coefficients into K coefficient groups, each coefficient group from the K coefficient groups associated with an entropy coding strategy based on one or more properties of the polygon mesh; performing, to generate a set of encoded coefficients, entropy encoding on each coefficient group from the K coefficient groups in accordance with a respective entropy coding strategy; and generating a video bitstream including the set of encoded coefficients, in which N and K are positive integers.

According to one or more embodiments, a method of decoding performed by at least one processor includes receiving a video bitstream including an encoded polygon mesh; splitting a set of N coefficients of the encoded polygon mesh into K coefficient groups, each coefficient group from the K coefficient groups associated with an entropy decoding strategy based on one or more properties of the polygon mesh; performing, to generate a set of decoded coefficients, entropy decoding on each coefficient group from the K coefficient groups in accordance with a respective entropy decoding strategy; and reconstructing the polygon mesh using the set of decoded coefficients, in which N and K are positive integers.

According to one or more embodiments, a method of performed by at least one processor includes processing a video bitstream including an encoded polygon mesh; in which a set of N coefficients is generated for the polygon mesh, in which the set of N coefficients are split into K coefficient groups, each coefficient group from the K coefficient groups associated with an entropy coding strategy based on one or more properties of the polygon mesh, in which a set of encoded coefficients are generated by performing entropy encoding on each coefficient group from the K coefficient groups in accordance with a respective entropy coding strategy, and in which N and K are positive integers.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is an illustration of multi-group distribution of coefficients, in accordance with embodiments of the present disclosure.

FIG. 4 is an illustration of entropy coding in polygonal mesh compression.

FIG. 5 is a flowchart of an example process for performing group entropy coding, in accordance with embodiments of the present disclosure.

FIGS. 6A-6C illustrate compression results on default connectionist temporal classification (CTC) configurations, in accordance with embodiments of the present disclosure.

FIGS. 7A-7C illustrate compression results on optimal CTC configurations, in accordance with embodiments of the present disclosure.

FIGS. 8A-8C illustrate group context coding results, in accordance with embodiments of the present disclosure.

FIGS. 9A-9C are an illustration of flip sign coding results, in accordance with embodiments of the present disclosure.

FIGS. 10A-10C illustrate adaptive maximum arithmetic coding range results, in accordance with embodiments of the present disclosure.

FIG. 11 illustrates lossy codec evaluation results, in accordance with embodiments of the present disclosure.

FIG. 12 illustrates lossy codec evaluation results, in accordance with embodiments of the present disclosure.

FIG. 13 illustrates a box distribution of converged probability of example context residuals.

FIG. 14 illustrates an example probability storage format, in accordance with embodiments of the present disclosure

FIG. 15 illustrates an example bit operation class PackedArray, in accordance with embodiments of the present disclosure.

FIG. 16 illustrates an example bit operation class PackArray, in accordance with embodiments of the present disclosure.

FIG. 17 illustrates an example storage format, in accordance with embodiments of the present disclosure.

FIG. 18 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

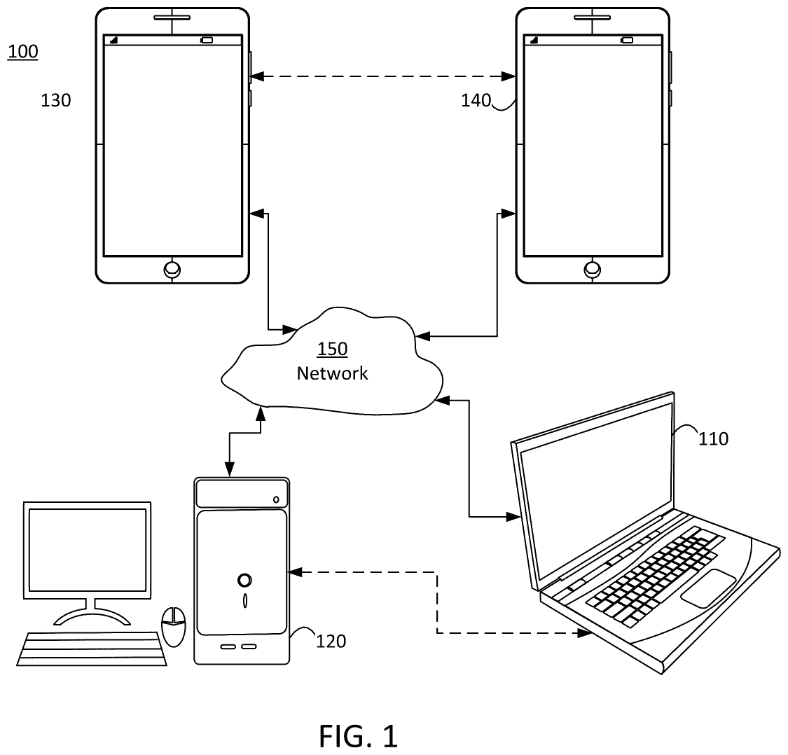

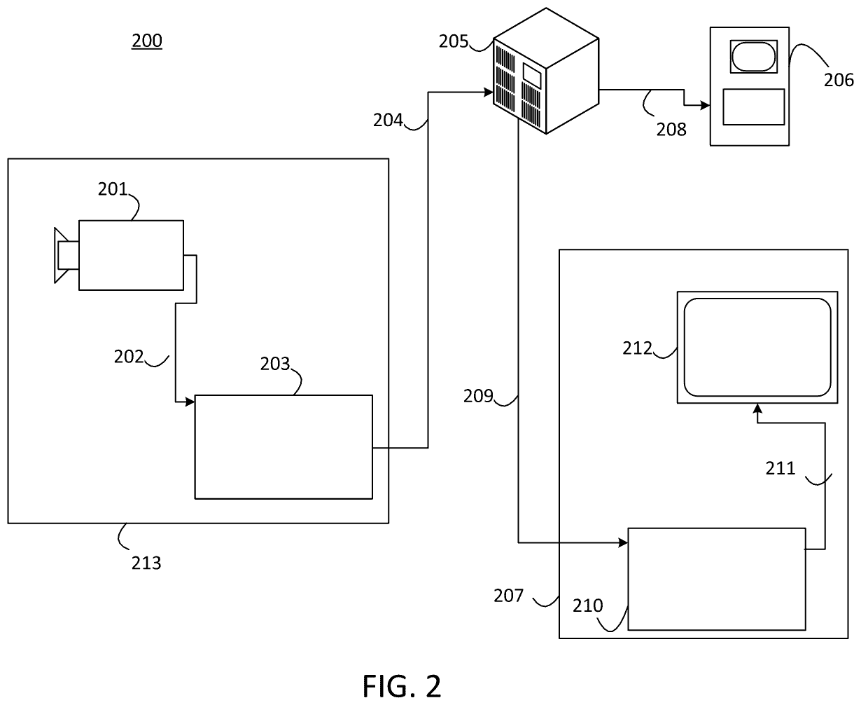

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

Embodiments of the present disclosure directed to a novel strategy to augment the efficiency of entropy coding. The method involves the preliminary classification of input residuals into multiple groups before undergoing entropy coding. This classification aims to reduce the entropy of the input coefficients, potentially leading to more streamlined and effective entropy coding. The proposed methods may be used separately or combined in any order and may be used for arbitrary polygonal mesh. The embodiments of the present disclosure may be applied individually or by any form of combinations. Further, the proposed methods may be implemented by processing circuitry (e.g., one or more processors or one or more integrated circuits).

The embodiments disclosed herein is applicable universally to any form of geometry or attribute coding, irrespective of the underlying polygonal mesh or the traversal algorithm employed. The disclosed embodiments may be implemented independently or in an integrated fashion, combining multiple approaches to achieve the desired outcome. In this context, residual or coefficient are mentioned as the input for entropy coding.

The embodiments of the present disclosure improve upon existing entropy coding techniques, such as Context Adaptive Binary Arithmetic Coding (CABAC), by addressing their sensitivity to the residual value range. According to one or more embodiments, n input coefficients are segregated into K groups based on the range of coefficients.

In one or more examples, the division may be formalized by the following definition:

$${G}_{k} = \{ {r}_{i} : {a}_{k - 1} < {r}_{i} \leq {a}_{k} \} , k = 1 , 2 , … , K , \qquad Eq . ( 1 )$$

where, Gₖ represents the k-th group of coefficients, rᵢ is the i-th residual of the input residual, and aₖ is pre-determined threshold that defines the group boundaries.

In practice, the value cᵢ is not available at the decoding stage of entropy. Therefore, according to one or more embodiments, the residual value of rᵢ^{prev} for the classification is used as follows:

$${G}_{k} = \{ {r}_{i} : {a}_{k - 1} < {r}_{i}^{prev} \leq {a}_{k} \} . \qquad Eq . ( 2 )$$

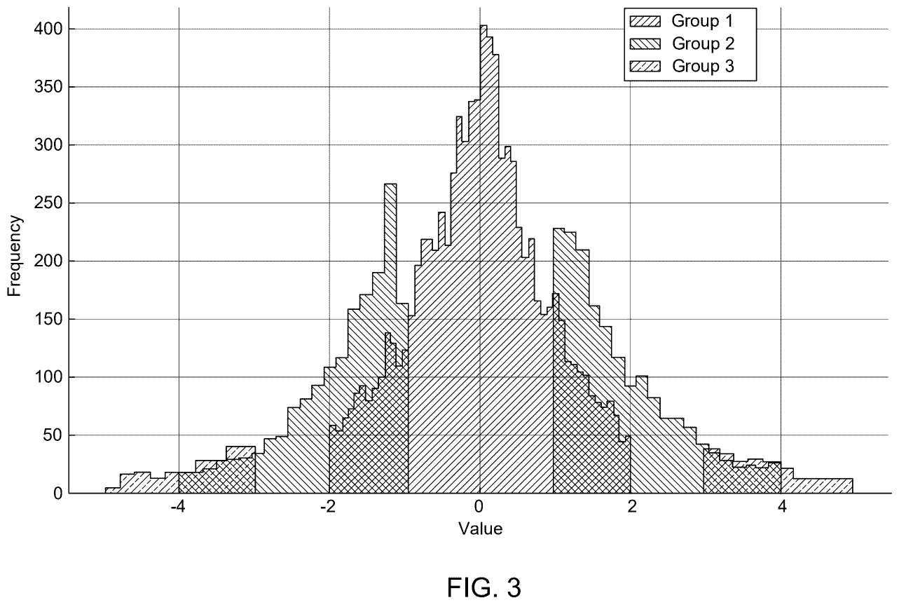

This approach eliminates the need for additional signaling while not increasing the encoder and decoder complexity significantly. In one or more examples, this classification is only applied to geometry residuals of quad dominant meshes. In one or more examples, for triangle meshes and non-position attributes, all residuals are considered to belong to one group. For example, a polygon mesh may include triangle sub-meshes that are assigned to one group, where each sub-mesh in the polygon mesh having more than three sides is split into one of K coefficient groups. FIG. 3 presents an example of the multi-group distribution, visually depicting how input coefficients are allocated to groups based on their range.

In one or more examples, the threshold is adaptively assigned based on the input bit depth. For example, K is set to 3, meaning 3 group contexts are used, named as low, mid, and high contexts. The thresholds may be set as follows:

$$\{ \begin{matrix}{a}_{0} & = 0 \\ {a}_{1} & = ⌊ \frac{max ( ( QP - 9 ) , 1 )}{2} ⌋ + 1 \\ {a}_{2} & = 11\end{matrix} \qquad Eq . ( 3 )$$

By grouping input coefficients based on their range, entropy coding strategies may be tailored to the distinct characteristics of each group, thereby enhancing encoding efficiency. For groups with a narrow range, predominantly zeros, a simplified encoding method suffices, exploiting the sparsity.

Conversely, for groups with a broad range, where coefficients are more varied, sophisticated methods like Golomb coding are employed, efficiently handling the diversity. This targeted approach ensures optimal compression by leveraging the statistical properties unique to each group, significantly improving the effectiveness of entropy coding.

The embodiments of the present disclosure enhance entropy coding efficiency by dynamically adjusting the thresholds for grouping input coefficients. The adjustments may be informed by the bit depth of the input mesh attributes, which correlates with the range and number of residuals expected in the data. The underlying principle asserts that a larger bit depth typically indicates a wider range of attribute values, leading to a higher probability of encountering more residuals, while a smaller bit depth suggests a limited range of values, and consequently, fewer residuals.

In one or more examples, approaches for adaptive features include a threshold adaptation and a group size adjustment. In the threshold adaptation, the thresholds for grouping may be modulated to be broader for attributes with higher bit depths and narrower for lower bit depths. In the group size adjustment, the number of groups (and thus their size) may be increased for meshes with greater bit depths and decreased for those with lesser bit depths.

According to one or more embodiments, for multi-pass encoding systems, the optimal thresholds that aim to minimize the overall group entropy as well as the signaling required for the decoder are calculated. In one or more examples, the group entropy residual may be given by the formula:

$$H ( {G}_{k} ) = {\sum }_{{r}_{i} ∈ {G}_{k}} p ( {c}_{i} ) {log}_{2} ( p ( {c}_{i} ) ) , \qquad Eq . ( 4 )$$

In one or more examples, an optimization is performed to identify the optimal threshold that maximizes the residual as follows:

$$arg {max}_{thres , K} \sum {H}_{0} ( {G}_{k} ) - H ( {G}_{k} ) , \qquad Eq . ( 5 )$$

where H₀(Gₖ) is the entropy of the k-group without considering the clustering effect. This can be solved by an extensive search algorithm.

According to one or more embodiments, adaptive group entropy coding may be extended to single pass encoding by using previously encoded residuals to estimate and adjust the optimal thresholds in subsequent entropy coding steps. According to one or more embodiments, the method adaptively enables group context coding, for example, enabled for higher than triangle mesh.

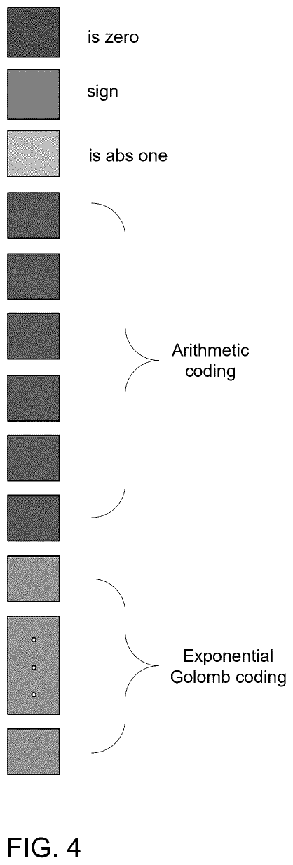

For Sign Bit Encoding, for each non-zero symbol encountered during the encoding process, the sign bit is encoded with careful consideration to maximize compression efficiency. The process is as follows. Positive Symbols: If the symbol is greater than zero (indicating a positive value), the encoder emits a bit of ‘1’ using the context dedicated for sign encoding (signCtx). This operation signals that the symbol being encoded is positive. Negative Symbols: Conversely, if the symbol is less than zero (indicating a negative value), the encoder emits a bit of ‘0’ using the same signCtx. This indicates a negative value for the symbol. FIG. 4 summarizes entropy coding of residuals.

According to one or more embodiments, instead of encoding the sign of residue, the flip sign is encoded, meaning whenever the sign of the residue is different from the sign of the previously encoded residue. The encoder assesses the sign relative to the previously encoded value's sign. The flipped sign can be derived and encoded as:

$$encode ( abs ( curSign - prevSign ) , signCtx ) , \qquad Eq . ( 6 )$$

where the curSign refers to current sign value and prevSign refers to previous sign value.

If the current value's sign is the same as the previous one, a ‘0’ is encoded; if it is different, a ‘1’ is encoded. By exploiting the correlation between consecutive signs, this method reduces redundancy, especially in sequences where long runs of the same sign frequently occur. An example of encoding the sign bit versus flip sign bit is shown in Table 1.

TABLE 1

| Symbol | −1 | −3 | −2 | 4 | 7 | 2 | 4 |
|---|---|---|---|---|---|---|---|
| Sign bit | 0 | 0 | 0 | 1 | 1 | 1 | 1 |
| Flip bit | 0 | 0 | 0 | 1 | 0 | 0 | 0 |

Like group context coding, the flip sign bit encoding is seen to be beneficial for geometry residuals of quad dominant meshes and hence is only enabled for these meshes. For triangle meshes and non-position attributes, the default sign bit encoding scheme is used.

According to one or more embodiments, the maximum value for arithmetic coding, designated as maxAC, may be dynamically determined based on the bit depth of the input values. This adaptive setting of maxAC allows the entropy coding algorithm to finely tune its parameters for each specific data set, accommodating the statistical characteristics that come with different bit depths. In one or more examples, the maxAC may be defined as follows:

$$maxAC = {2}^{max Bit} - 1 , \qquad Eq . ( 7 )$$

where, maxBit is the number of bits coded using arithmetic coder.

The parameter maxBit may be constrained by the input bit depth of corresponding attribute, calculated as follows.

$$max Bit ( position ) = ⌈ \frac{2 \times ( min ( max ( ( QP - 9 ) , 0 ) , 7 ) )}{3} + 3 ⌉ , \qquad Eq . ( 8 )$$

$$max Bit ( texture coordinates ) = \{ \begin{matrix}6 , & QT > 10 \\ 5 , & QT \leq 10\end{matrix} , \qquad Eq . ( 9 )$$

$$max Bit ( nromal ) = \{ \begin{matrix}6 , & QN > 7 \\ 4 , & QN \leq 7\end{matrix} . \qquad Eq . ( 10 )$$

In one or more examples, the adaptive maximum range may be applied for all meshes and all the attributes (position, texture coordinates and normal). One bit may be used to signal whether each of these tools are enabled or not (3 bits in total).

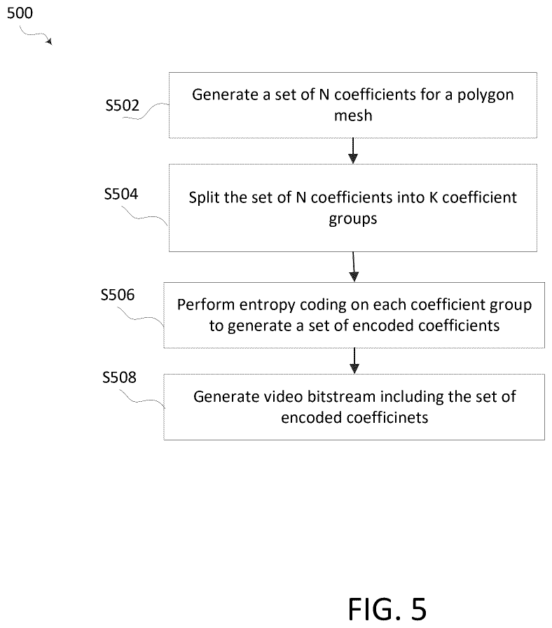

FIG. 5 illustrates a flow chart of an example encoding process 400. The encoding process 400 may be performed by the encoder 203 (FIG. 2). The process 400 may start at operation S502 where a set of N (N>0) coefficients for a polygon mesh. For example, the set of N coefficients may be generated by performing a decimation process on the polygon mesh or sampling the polygon mesh to reduce a number of vertices in the mesh. In one or more examples, the set of N coefficients may be generated in accordance with an encoding scheme in which one or more vertices are encoded and predictors or residuals of neighboring vertices are encoded.

The process proceeds to operation S504 where the set of N coefficients is split into K (K>0) coefficient groups. For example, the N coefficients may be split in accordance with one or more properties of the polygon mesh (e.g., bit mesh).

The process proceeds to operation S506 where entropy coding is performed on each coefficient group to generate a set of encoded coefficients. For example, each coefficient group from the K coefficient groups may be associated with a respective entropy encoding strategy that is optimized for each coefficient group.

The process proceeds to operation S508 where a video bitstream is generated including the set of encoded coefficients.

A decoding process may also be performed on the video bitstream including the set of encoded coefficients. For example, the decoder 210 (FIG. 2) may receive the video bitstream including the set of encoded coefficients. The decoder 210 may split the set of coefficients of the encoded polygon mesh into K coefficient groups, where each coefficient group from the K coefficient groups associated with an entropy decoding strategy based on one or more properties of the polygon mesh. The decoder 210 may perform, to generate a set of decoded coefficients, entropy decoding on each coefficient group from the K coefficient groups in accordance with a respective entropy decoding strategy. Furthermore, the decoder 210 may reconstruct the polygon mesh using the set of decoded coefficients,

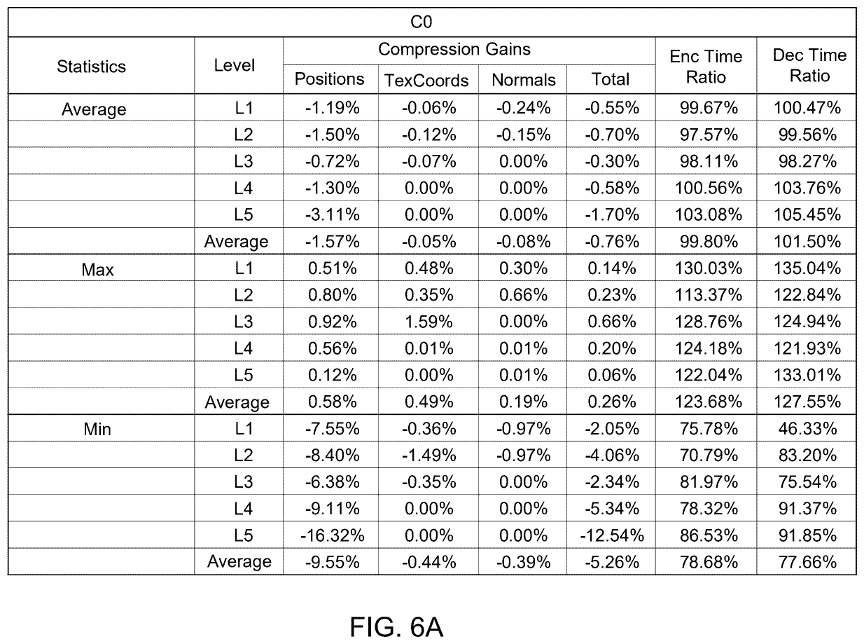

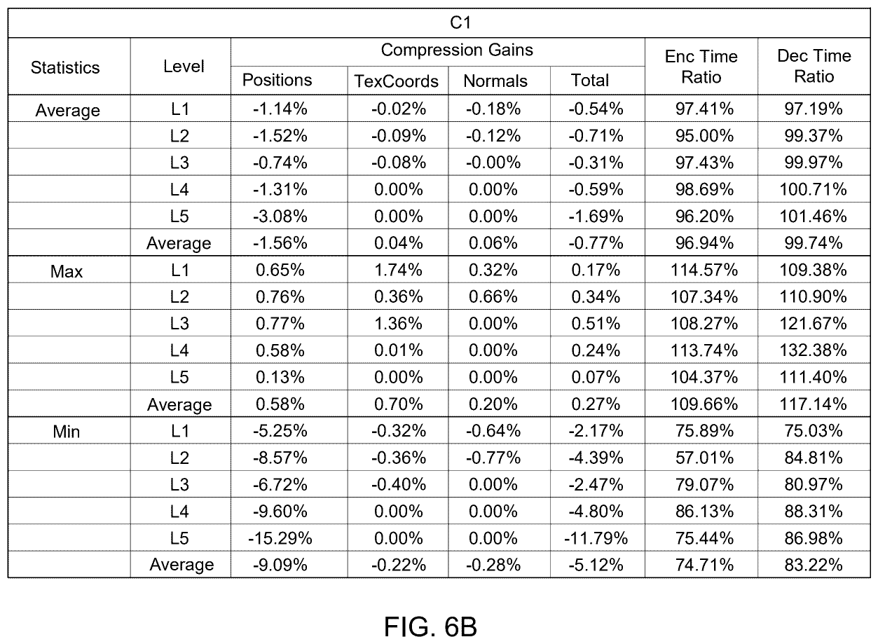

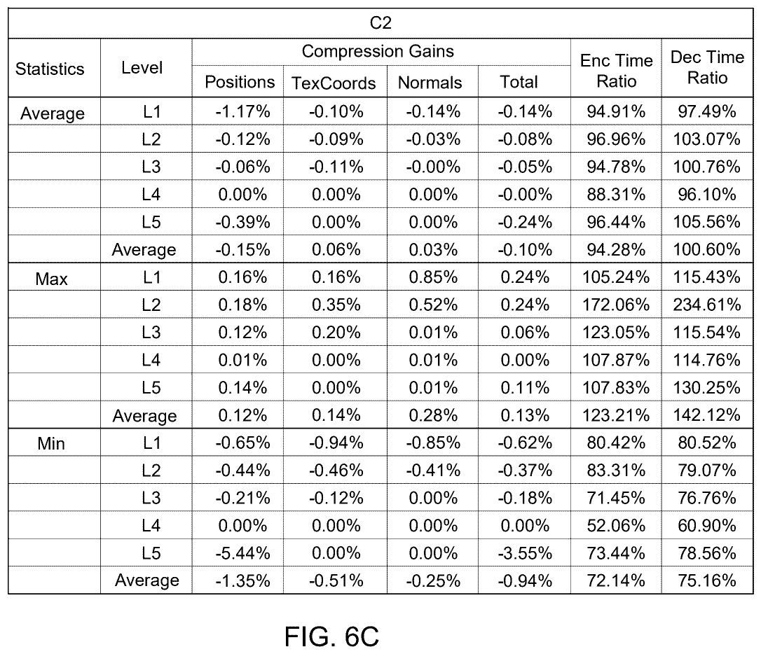

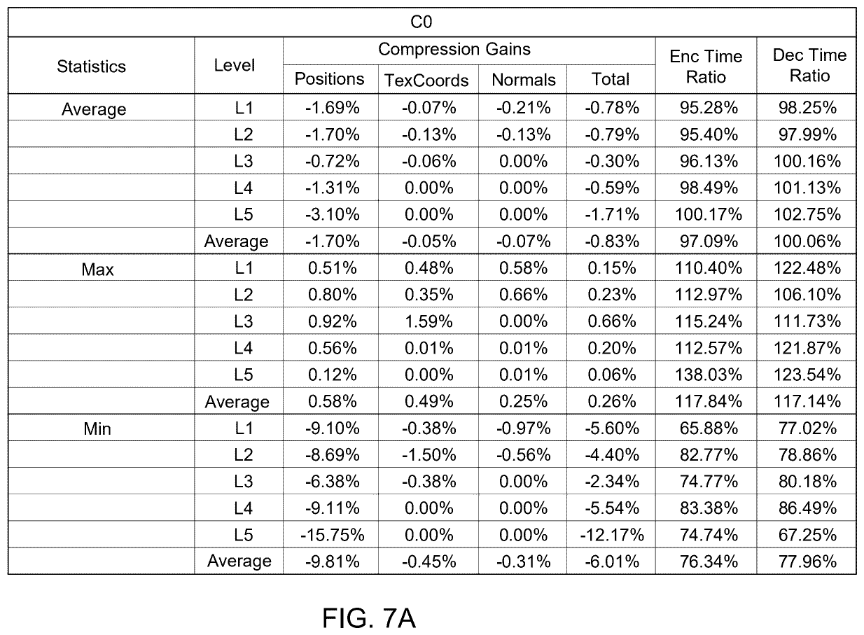

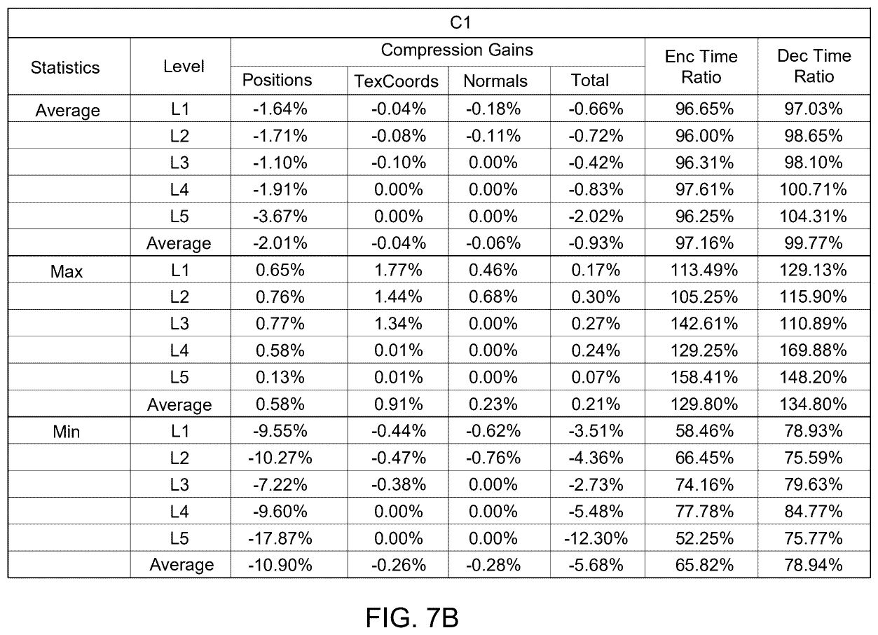

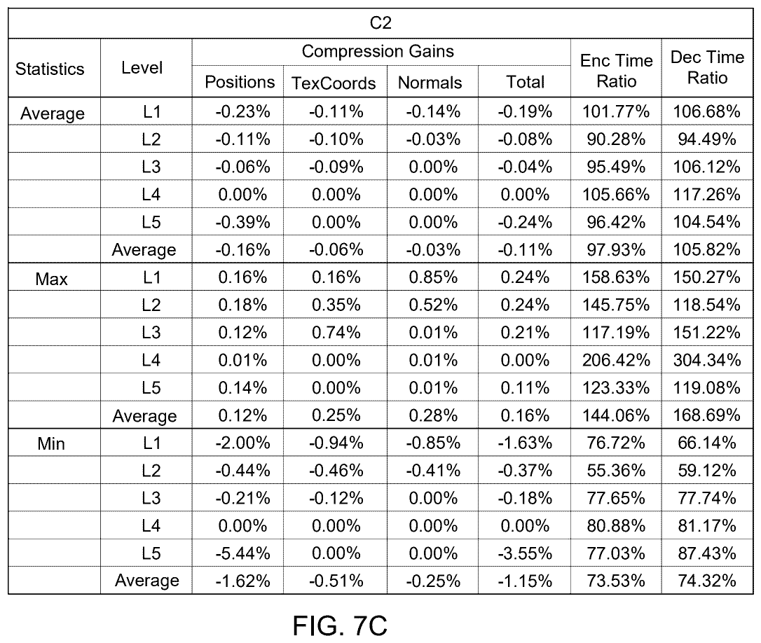

The improvements resulting from the embodiments of the present disclosure are compared with PMC Test Model v2.0. FIGS. 6A-6C and 7A-7C show the results with default and optimal CTC configurations, respectively. The experiments were conducted using the test scripts with 8 workers in parallel. As illustrated in FIGS. 6 and 7, there is consistent coding gain for all attributes. The gain is higher at higher bit depths due to larger residue magnitudes

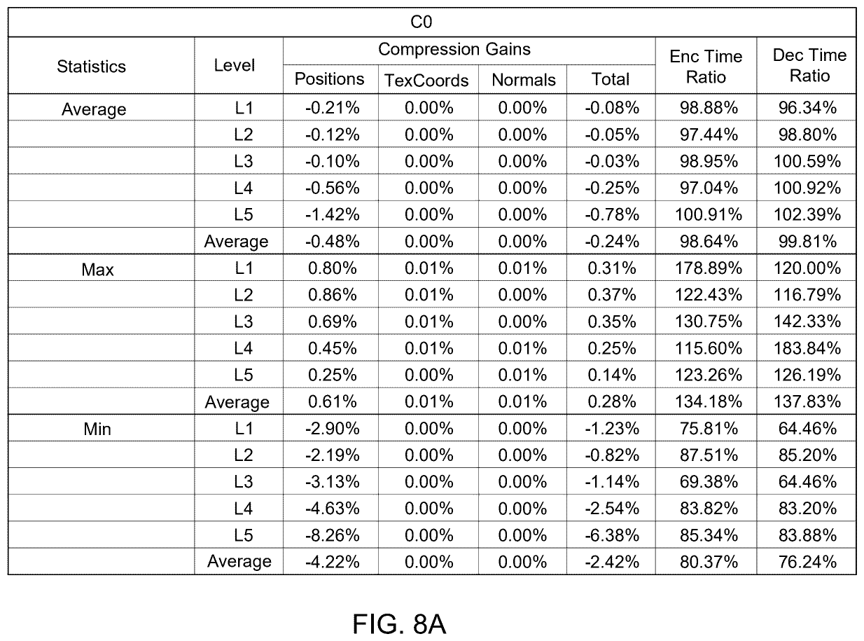

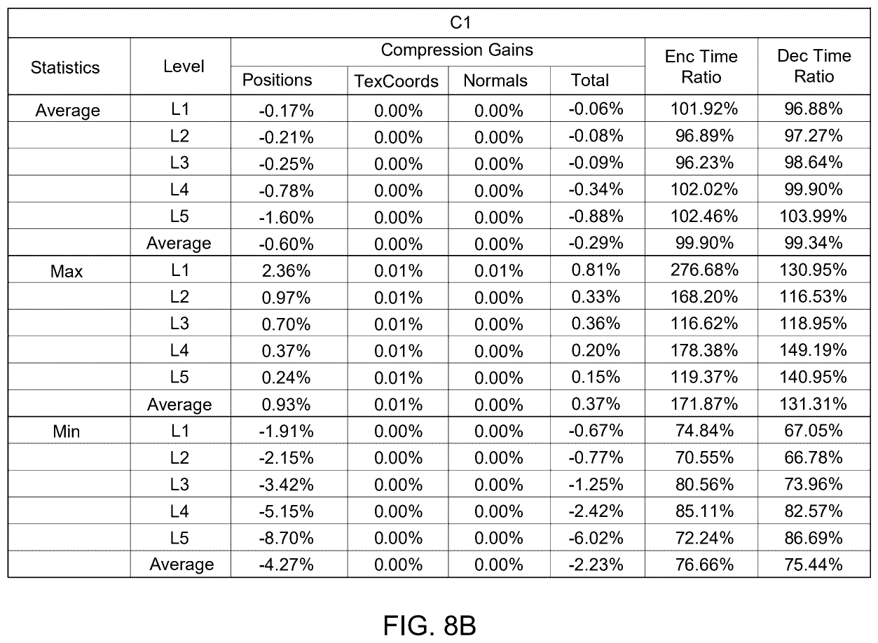

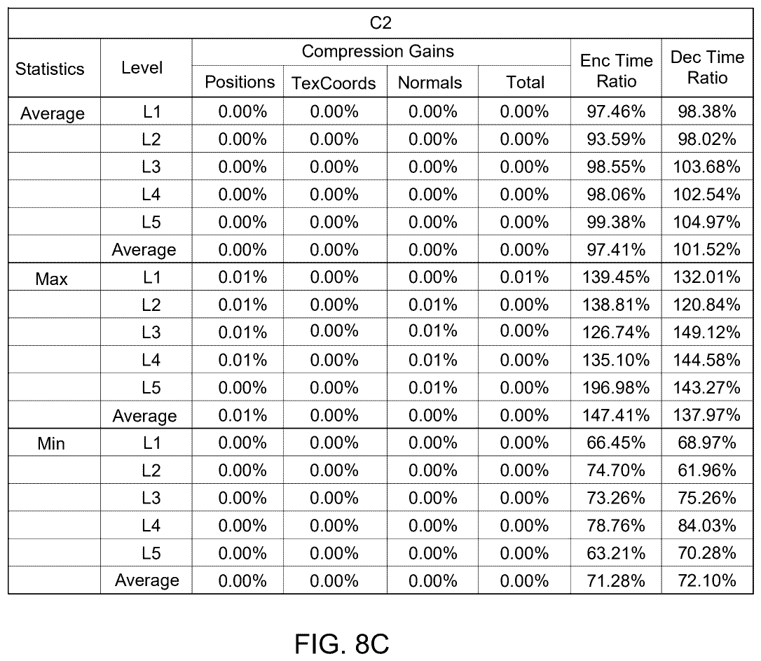

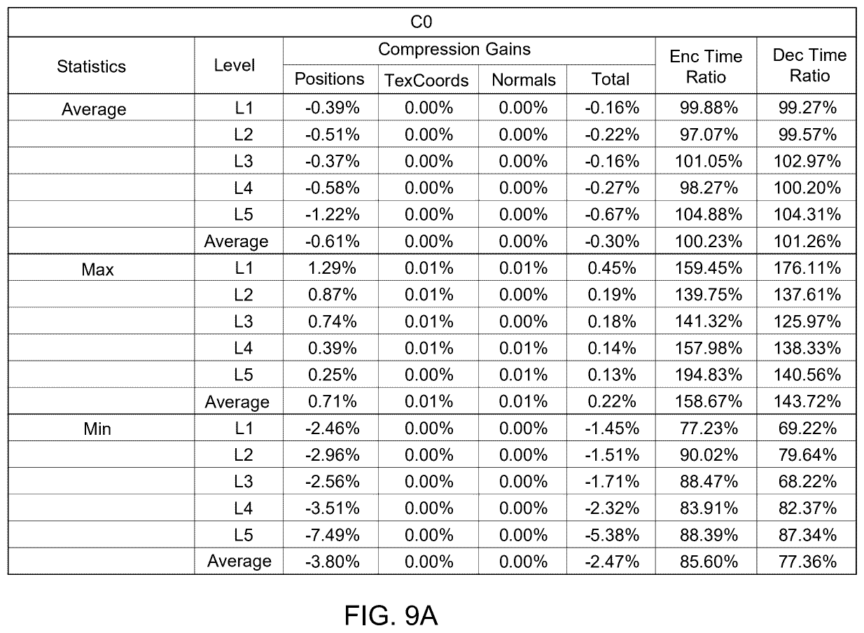

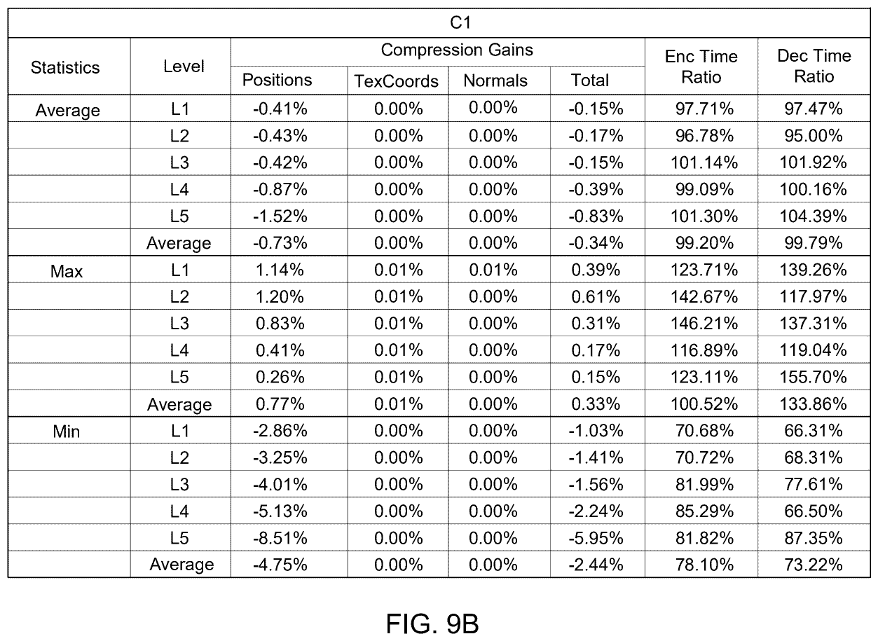

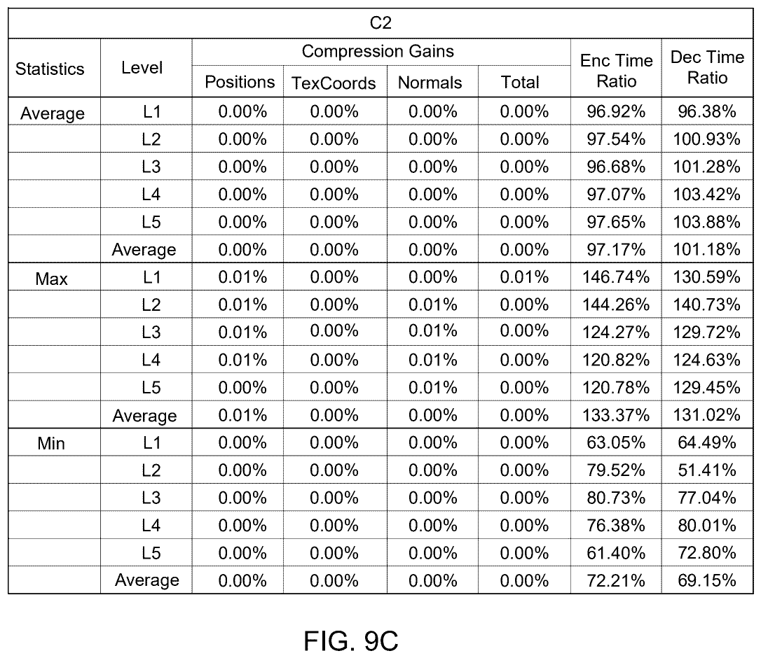

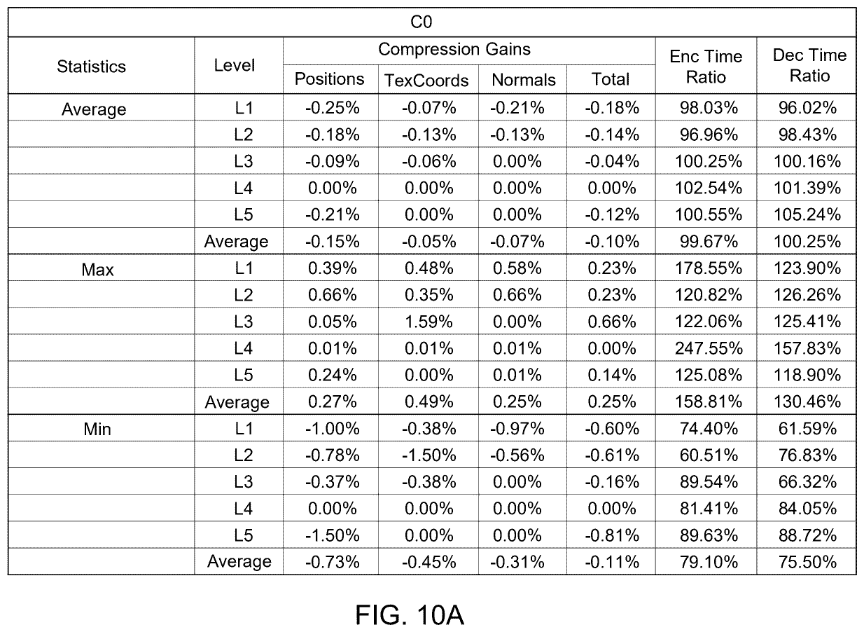

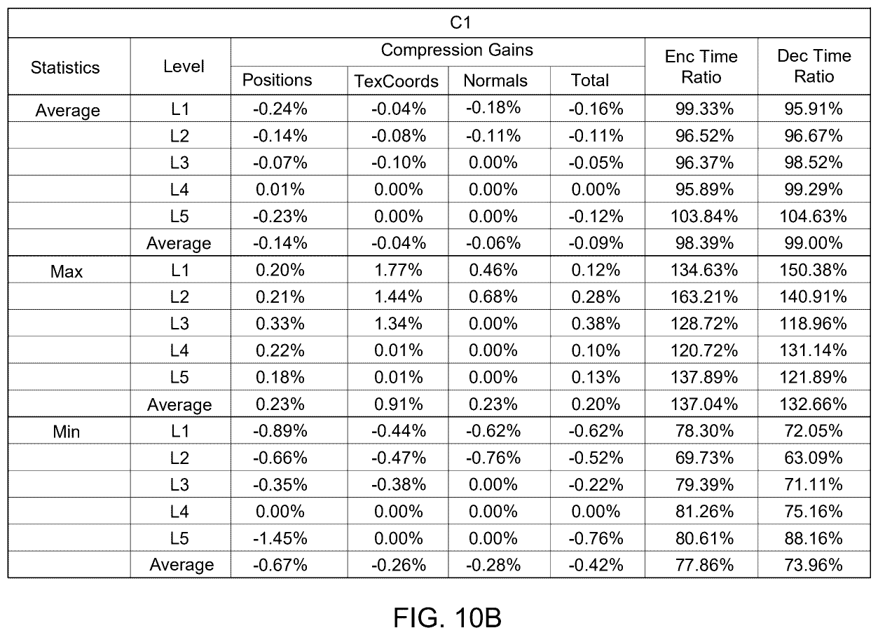

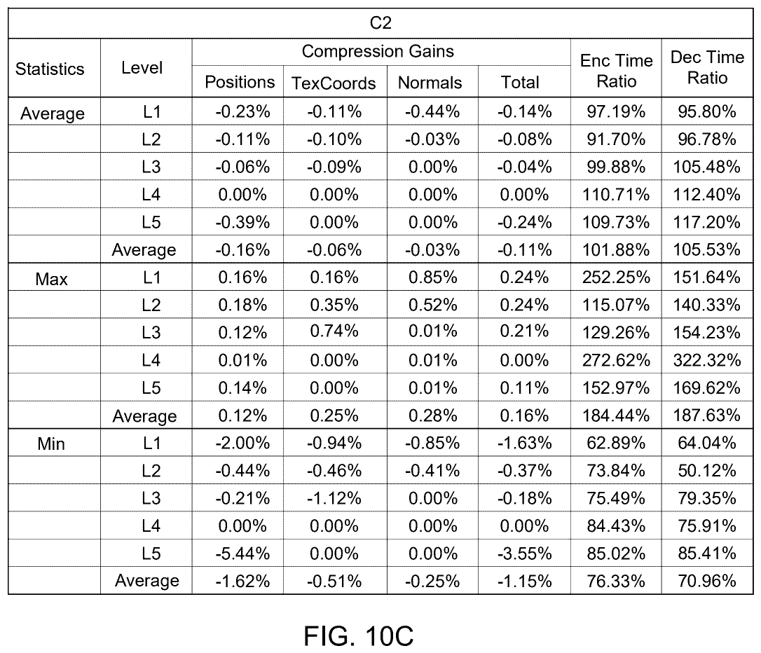

In FIGS. 8A-8C, the comparison with the PMC Test Model v2.0 anchor for group context coding is illustrated. In FIGS. 9A-9C, the comparison with the PMC Test Model v2.0 anchor for flip sign coding is illustrated. In FIGS. 10A-10C, the comparison with the PMC Test Model v2.0 anchor for adaptive maximum arithmetic coding range is illustrated. From FIGS. 8-10, it is illustrated that all three improvements bring gains individually as well.

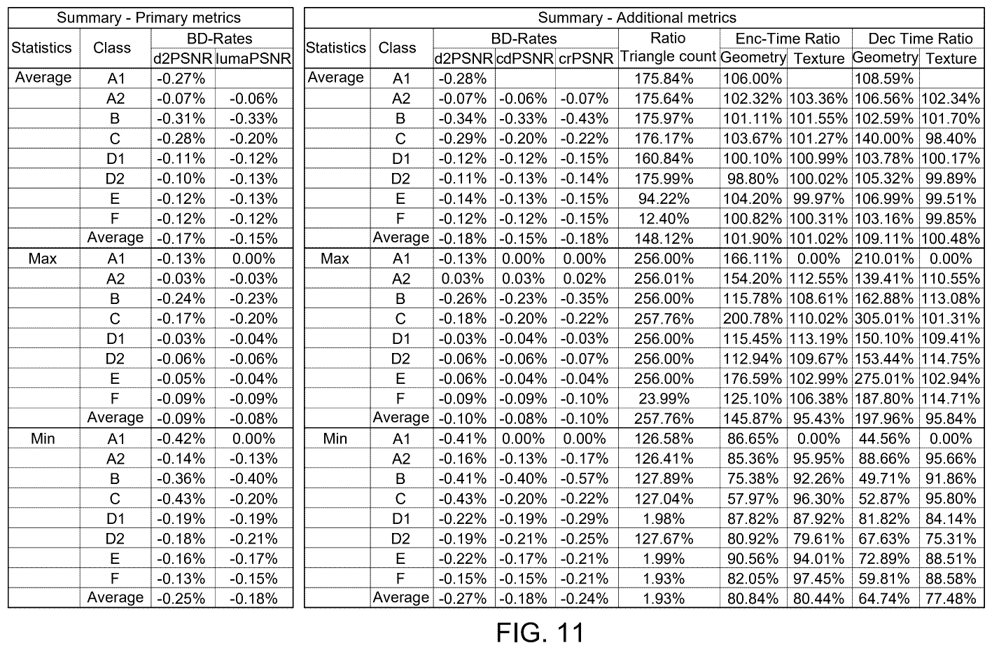

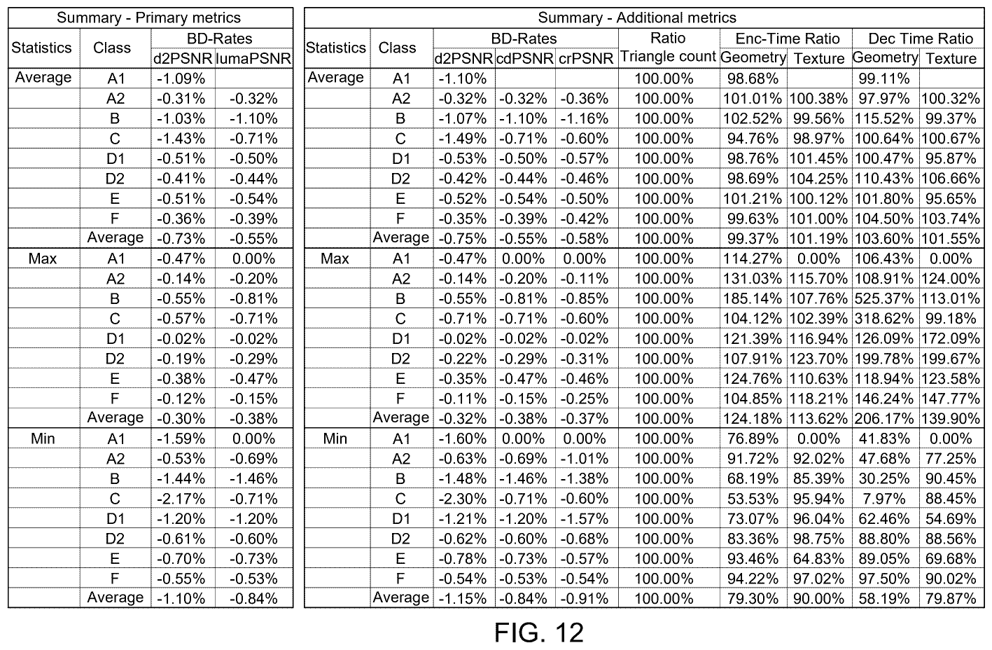

Results are also shown for the lossy tests using the proposed CTC and lossy reporting template as well as existing test configurations in PMC test model v2.0. The results in FIGS. 11 and 12 show that the embodiments of the present disclosure also work with bit depths lower than L1 and entropy coding of residuals of base meshes.

In VVM PMC test model v2.0, the probability initialization of entropy coding is involved in ArithmeticContext and ACExpGolombContext. Currently the initialization of the entropy coding probability is always set to 0.5 (uint16_t 32768 in the code). The embodiments of the present disclosure are directed to a methodology to derive a set of initialized probability for each context that can achieve better coding gain performance in lossless and lossy conditions. The embodiments provide improved initial probabilities in position, texture coordinate and normal coding contexts.

The context used in geometry coding in VVM PMC test model v2.0 are in Table 2. In ArithmeticContext, each entry of the array is assigned with an initial probability. For ACExpGolombContext, each entry in the array has class members of vectors with size sz, as shown in Table 3, and the vector entries are assigned with initial probabilities.

TABLE 2

| | | ACExpGolombContext | |
|---|---|---|---|
| | ArithmeticContext | (<sizeLog2>) | |
| Position: | ffanAddCtxs0[5]; | ACExpGolombContext<6> | |
| Polygon | fanAddCtx1; | vertexLocalIndexCtxs[3];//(sz=1) | |
| fan | ffanSizeCtxs[16][7]; | ACExpGolombContext<6> residualCtxs[6]; | |
| | ffanSizeExpGolombCtx; | // (sz=3) | |
| | faceVertexCountCtxs[3]; | | |
| | faceVertexCountExpGolombCtx; | | |
| | configCtxs[5][8]; | | |
| | vertexStateCtx; | | |
| | vertexIndexPredCtx; | | |
| | vertexIndexDirectionCtx; | | |
| | remainingVerticesStateCtx; | | |
| | singlewayPredictionModeCtxs[3]; | | |
| | multiwayPredictionModeCtxs[7]; | | |
| | predictorIndexCtxs[6][8][3]; | | |
| Position: | ------------------------------------- | ACExpGolombContext<2> | faceDegreeCtxs[7]; |
| Dual | | //(sz=1) | |
| degree | | ACExpGolombContext<3> | vertexDegreeCtxs[7]; |
| | | //(sz=1) | |
| | | ACExpGolombContext<3> | |
| | | dummyFaceDegreeCtx; | //(sz=1) |
| | | ACExpGolombContext<2> | |
| | | faceInSplitVertexIndexCtx; | //(sz=1) |
| Texture | singlewayPredictionModeCtxs[3]; | ACExpGolombContext<6>residualCtxs[8];//(sz=2) | |
| Coordinate | multiwayPredictionModeCtxs[7]; | ACExpGolombContext<6> | attributeIndexCtx; |
| | predictorIndexCtxs[8][3]; | //(sz=1) | |
| | vertexAttributeCountCtxs[3][4]; | | |
| | attributeIndexIsNewCtx; | | |
| | attributeLocalIndexCtxs[10][5]; | | |
| | attributeIndexIsSameCtx[2]; | | |

| | | |
|---|---|---|
| Normal | Same as above | ACExpGolombContext<6>residualCtxs[8]; |
| | | //( sz=3) |

| | |
|---|---|
| ACExpGolombContext<6> | attributeIndexCtx; |

//(sz=1)

TABLE 3

| | |
|---|---|
| std::vector<ArithmeticContext> isZeroCtx; | //size= sz |
| std::vector<ArithmeticContext> isAbsOneCtx; | //size= sz |
| std::vector<ArithmeticContext> signCtx; | //size= sz |
| std::vector<ArithmeticContext> acCtx; | //size= sz * |

ipower2(sizeLog2)

| | |
|---|---|
| std::vector<ArithmeticContext> expGolombCtx; | //size= sz |

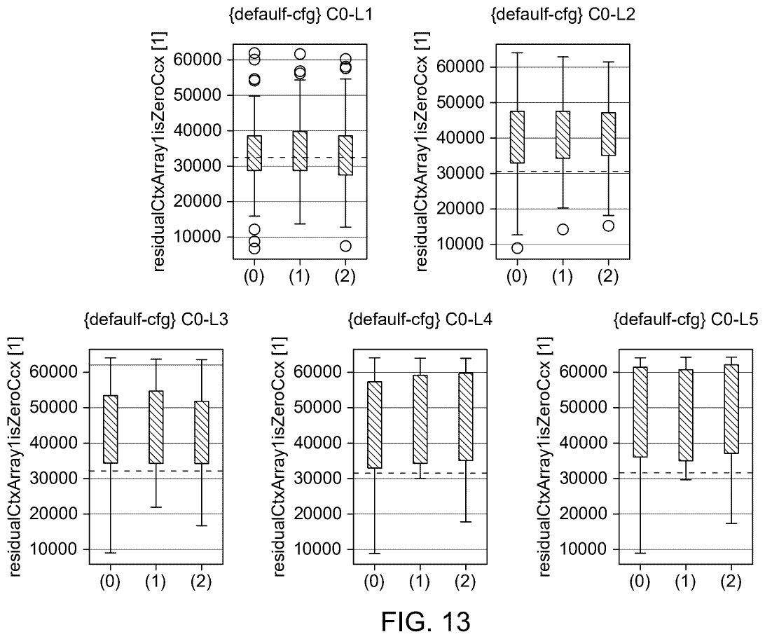

In the current Test Model, the above-mentioned initial probabilities are fixed to 0.5 (uint16_t 32768 in the code). Furthermore, as the encoding proceeds, the probability will be updated based on the content for better compression. Upon the end of the encoding, each context has a different converged probability, and it is observed that for the same context, the converged probability is significantly different according to different geometry coding bit depths QP (qp: [9 10 11 13 16] for position, qt: [8 9 10 12 14] for texture coordinate, and qn: [6 7 8 9 10] for normal; corresponding to L1 to L5, respectively). FIG. 13 shows the difference in converged probability using the example of context residualCtxsArray[1].isZeroCtx(0)(1)(2) from L1 to L5 (qp: [9 10 11 13 16]). In FIG. 13, the box distribution of converged probability (Y-axis) of example context residualCtxsArray[1].isZeroCtx(0)(1)(2) is illustrated. Each boxplot is derived from 53 meshes in lossless coding in default a configuration. Red dashed line is probability 0.5 (uint16_t 32768 in the code) and the orange line in the boxplot is the median. It can be observed that the medians are significantly different across different qps.

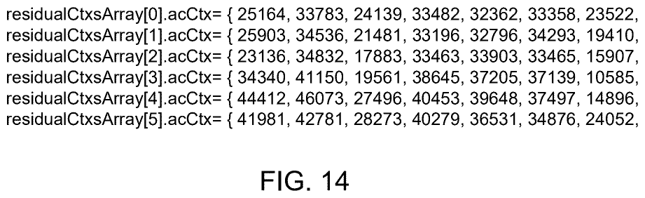

According to one or more embodiments, a centroid (central mass) of each boxplot in the training set is used as the initial probability, for all the context according to different QP in the test model. In one or more examples, the derived predefined initial probability may be stored beforehand using the format illustrated in FIG. 14.

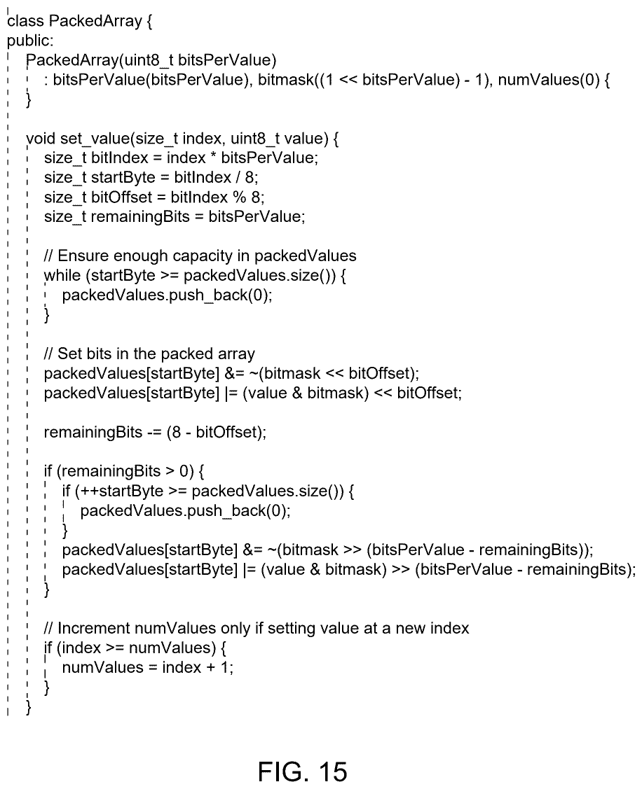

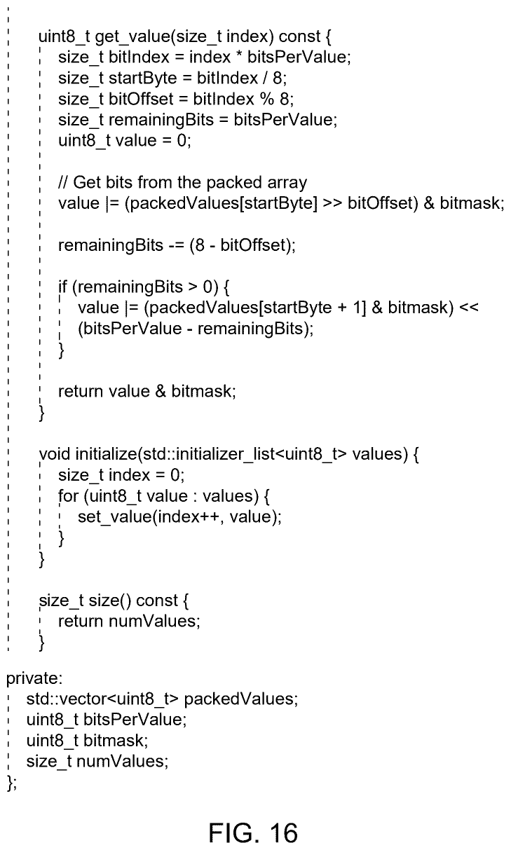

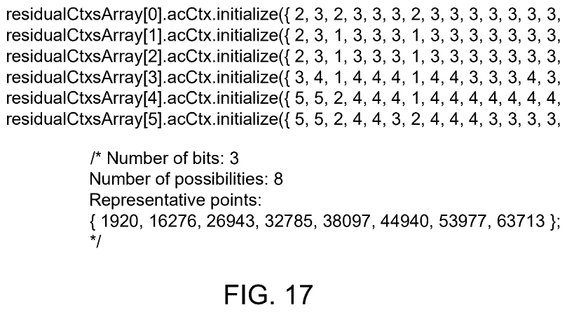

In one or more examples, for the contexts used in these embodiments, which are listed in Table 2, the total number of them are 1749+160+1731+2275=5915, multiplied by 5 levels, which is 29,575, and each context is stored in 2 Bytes (uint16_t); this is 59,150 Bytes in total. To reduce this overhead, it is proposed to represent each context by only 3 bits (8 possibilities) by bit manipulation, as illustrated in FIGS. 15 and 16 (PackedArray class). Each of the 8 possibilities (0˜7) corresponds to representative points (in the sense of minimal error), as illustrated in FIG. 17, derived from all possible probabilities in the training set. This will reduce the size of the stored context to (59,150/16)*3=11,090 Bytes.

The embodiments of the present disclosure reduce context storage size from 5 stored levels to 2. For example, to further reduce the size, an interpolation method is used. Instead of storing context for 5 levels, the embodiments store context for 2 end-levels (L1 and L5). For testing QP∈{qp, qt, qn} within QP[0] and QP[4], an inverse-distance-based interpolation is used to derive the context probability:

$$context ( testQP ) = \frac{QP [ 4 ] - testQP}{QP [ 4 ] - QP [ 0 ]} context ( QP [ 0 ] ) + \frac{testQP - QP [ 0 ]}{QP [ 4 ] - QP [ 0 ]} context ( QP [ 4 ] ) . \qquad Eq . ( 11 )$$

For testing QP less than QP[0] and greater than QP[4], the context of QP=QP[0] and QP[4] are used, respectively. The stored size may be reduced to two-fifth of above: (11,090 Bytes/5)*2=4,436 Bytes.

Proposed initial probability of entropy coding associated with Table 2 are listed in the following section including: Position Coding, Texture Coordinate Coding, and Normal Coding sections. The probability will be the in the number in the associated Sorted Centroids, indexed by the number in the associated initialize array.

### Position Coding:

### Texture Coordinate Coding:

/* Number of bits: 3
Number of possibilities: 8
Sorted Centroids:
{ 1089, 14919, 26867, 32781, 37929, 44588, 53359, 63477 };
*/
if (tbits == 8) {
singlewayPredictionModeCtxsArray.initialize({ 3, 1, 2, });
multiwayPredictionModeCtxsArray.initialize({ 6, 5, 3, 6, 2, 3, 3, });
predictorCtxsArray.initialize({ 1, 2, 3, 3, 3, 3, 2, 4, 1, 4, 2, 0, 2, 2, 1, 1, 2, 4, 1, 3, 4, 1, 5, 5, });
residualCtxsArray[0].isZeroCtx.initialize({ 4, 3, });
residualCtxsArray[1].isZeroCtx.initialize({ 2, 2, });
residualCtxsArray[2].isZeroCtx.initialize({ 2, 1, });
residualCtxsArray[3].isZeroCtx.initialize({ 1, 2, });
residualCtxsArray[4].isZeroCtx.initialize({ 1, 1, });
residualCtxsArray[5].isZeroCtx.initialize({ 1, 1, });
residualCtxsArray[6].isZeroCtx.initialize({ 1, 1, });
residualCtxsArray[7].isZeroCtx.initialize({ 1, 1, });
residualCtxsArray[0].isAbsOneCtx.initialize({ 3, 3, });
residualCtxsArray[1].isAbsOneCtx.initialize({ 1, 1, });
residualCtxsArray[2].isAbsOneCtx.initialize({ 1, 1, });
residualCtxsArray[3].isAbsOneCtx.initialize({ 0, 0, });
residualCtxsArray[4].isAbsOneCtx.initialize({ 0, 0, });
residualCtxsArray[5].isAbsOneCtx.initialize({ 1, 1, });
residualCtxsArray[6].isAbsOneCtx.initialize({ 1, 1, });
residualCtxsArray[7].isAbsOneCtx.initialize({ 1, 1, });
residualCtxsArray[0].signCtx.initialize({ 3, 3, });
residualCtxsArray[1].signCtx.initialize({ 3, 3, });
residualCtxsArray[2].signCtx.initialize({ 4, 4, });
residualCtxsArray[3].signCtx.initialize({ 4, 4, });
residualCtxsArray[4].signCtx.initialize({ 4, 4, });
residualCtxsArray[5].signCtx.initialize({ 3, 3, });
residualCtxsArray[6].signCtx.initialize({ 5, 5, });
residualCtxsArray[7].signCtx.initialize({ 3, 3, });
residualCtxsArray[0].acCtx.initialize({ 5, 4, 3, 4, 4, 3, 3, 4, 3, 3, 3, 3, 3, 3, 3, 4, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 4, 4, 3, 4, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[1].acCtx.initialize({ 5, 5, 3, 5, 3, 3, 3, 5, 3, 3, 3, 3, 3, 3, 3, 5, 3, 3, 3, 3, 3, 3,
3, 3, 3, 3, 3, 3, 3, 3, 3, 4, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 5, 5, 3, 5, 3, 3, 3, 5, 3, 3, 3, 3, 3, 3, 3, 5, 3, 3, 3, 3, 3, 3, 3, 3, 3, 3, 3, 3, 3, 3, 3, 5, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[2].acCtx.initialize({ 5, 5, 3, 5, 3, 3, 3, 4, 3, 3, 3, 3, 3, 3, 3, 4, 3, 3, 3, 3, 3, 3,
3, 3, 3, 3, 3, 3, 3, 3, 3, 4, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 5, 5, 3, 5, 3, 3, 3, 4, 3, 3, 3, 3, 3, 3, 3, 4, 3, 3, 3, 3, 3, 3, 3, 3, 3, 3, 3, 3, 3, 3, 3, 4, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[3].acCtx.initialize({ 6, 6, 3, 6, 3, 3, 3, 5, 3, 3, 3, 3, 3, 3, 3, 5, 3, 3, 3, 3, 3, 3,
3, 3, 3, 3, 3, 3, 3, 3, 3, 5, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 6, 3, 6, 3, 3, 3, 5, 3, 3, 3, 3, 3, 3, 3, 5, 3, 3, 3, 3, 3, 3, 3, 3, 3, 3, 3, 3, 3, 3, 3, 5, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[4].acCtx.initialize({ 5, 5, 3, 5, 3, 3, 3, 5, 3, 3, 3, 3, 3, 3, 3, 5, 3, 3, 3, 3, 3, 3,
3, 3, 3, 3, 3, 3, 3, 3, 3, 5, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 5, 5, 3, 5, 3, 3, 3, 5, 3, 3, 3, 3, 3, 3, 3, 5, 3, 3, 3, 3, 3, 3, 3, 3, 3, 3, 3, 3, 3, 3, 3, 5, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[5].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[6].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[7].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[0].expGolombCtx.initialize({ 3, 3, });
residualCtxsArray[1].expGolombCtx.initialize({ 3, 3, });
residualCtxsArray[2].expGolombCtx.initialize({ 3, 3, });
residualCtxsArray[3].expGolombCtx.initialize({ 3, 3, });
residualCtxsArray[4].expGolombCtx.initialize({ 3, 3, });
residualCtxsArray[5].expGolombCtx.initialize({ 3, 3, });
residualCtxsArray[6].expGolombCtx.initialize({ 3, 3, });
residualCtxsArray[7].expGolombCtx.initialize({ 3, 3, });
residualCtxsArray[0].expGolombOrder.initialize({ 0, 0, });
residualCtxsArray[1].expGolombOrder.initialize({ 0, 0, });
residualCtxsArray[2].expGolombOrder.initialize({ 0, 0, });
residualCtxsArray[3].expGolombOrder.initialize({ 0, 0, });
residualCtxsArray[4].expGolombOrder.initialize({ 0, 0, });
residualCtxsArray[5].expGolombOrder.initialize({ 0, 0, });
residualCtxsArray[6].expGolombOrder.initialize({ 0, 0, });
residualCtxsArray[7].expGolombOrder.initialize({ 0, 0, });
vertexAttributeCountCtxsArray.initialize({ 3, 3, 3, 3, 3, 3, 3, 3, 3, 3, 3, 3, });
attributeIndexIsNewCtxArray.initialize({ 0, });
attributeLocalIndexCtxsArray.initialize({ 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, });
attributeIndexIsSameCtxArray.initialize({ 1, 7, });
attributeIndexCtxArray[0].isZeroCtx.initialize({ 5, });
attributeIndexCtxArray[0].isAbsOneCtx.initialize({ 4, });
attributeIndexCtxArray[0].signCtx.initialize({ 3, });
attributeIndexCtxArray[0].acCtx.initialize({ 4, 4, 2, 4, 3, 3, 2, 4, 3, 3, 3, 3, 3, 3, 2, 3, 3, 3, 3, 3,
3, 3, 3, 3, 3, 3, 3, 3, 3, 3, 2, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 2, 3, });
attributeIndexCtxArray[0].expGolombCtx.initialize({ 3, });
attributeIndexCtxArray[0].expGolombOrder.initialize({ 0, });
}else if (tbits == 14) {
singlewayPredictionModeCtxsArray.initialize({ 6, 1, 3, });
multiwayPredictionModeCtxsArray.initialize({ 5, 2, 2, 2, 5, 3, 3, });
predictorCtxsArray.initialize({ 1, 3, 3, 3, 3, 3, 6, 6, 1, 7, 0, 3, 7, 0, 5, 4, 5, 1, 3, 6, 2, 5, 6, 1, });
residualCtxsArray[0].isZeroCtx.initialize({ 4, 4, });
residualCtxsArray[1].isZeroCtx.initialize({ 6, 6, });
residualCtxsArray[2].isZeroCtx.initialize({ 6, 6, });
residualCtxsArray[3].isZeroCtx.initialize({ 5, 5, });
residualCtxsArray[4].isZeroCtx.initialize({ 5, 5, });
residualCtxsArray[5].isZeroCtx.initialize({ 4, 3, });
residualCtxsArray[6].isZeroCtx.initialize({ 3, 3, });
residualCtxsArray[7].isZeroCtx.initialize({ 4, 4, });
residualCtxsArray[0].isAbsOneCtx.initialize({ 5, 4, });
residualCtxsArray[1].isAbsOneCtx.initialize({ 6, 6, });
residualCtxsArray[2].isAbsOneCtx.initialize({ 5, 5, });
residualCtxsArray[3].isAbsOneCtx.initialize({ 3, 3, });
residualCtxsArray[4].isAbsOneCtx.initialize({ 3, 3, });
residualCtxsArray[5].isAbsOneCtx.initialize({ 2, 2, });
residualCtxsArray[6].isAbsOneCtx.initialize({ 2, 1, });
residualCtxsArray[7].isAbsOneCtx.initialize({ 2, 2, });
residualCtxsArray[0].signCtx.initialize({ 3, 3, });
residualCtxsArray[1].signCtx.initialize({ 3, 3, });
residualCtxsArray[2].signCtx.initialize({ 3, 3, });
residualCtxsArray[3].signCtx.initialize({ 3, 3, });
residualCtxsArray[4].signCtx.initialize({ 4, 4, });
residualCtxsArray[5].signCtx.initialize({ 4, 4, });
residualCtxsArray[6].signCtx.initialize({ 5, 5, });
residualCtxsArray[7].signCtx.initialize({ 3, 3, });
residualCtxsArray[0].acCtx.initialize({ 3, 4, 2, 3, 3, 3, 2, 3, 3, 3, 3, 3, 3, 3, 2, 3, 3, 3, 3, 3, 3, 3,
3, 3, 3, 3, 3, 3, 3, 3, 2, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 2, 3, 3, 4, 3, 3, 3, 3, 2, 3, 3, 3, 3, 3, 3, 3, 2, 3, 3, 3, 3, 3, 3, 3, 3, 3, 3, 3, 3, 3, 3, 3, 2, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 2, 3, });
residualCtxsArray[1].acCtx.initialize({ 5, 5, 3, 4, 4, 4, 2, 4, 3, 3, 4, 4, 3, 3, 1, 3, 3, 3, 3, 4, 3, 3,
3, 3, 3, 3, 3, 3, 3, 3, 1, 3, 3, 3, 3, 3, 3, 3, 3, 3, 3, 3, 3, 4, 3, 3, 3, 3, 4, 3, 3, 3, 3, 3, 3, 3, 3, 3, 3, 3,
3, 3, 1, 3, 5, 5, 3, 4, 4, 4, 1, 4, 3, 3, 4, 4, 3, 3, 1, 3, 3, 3, 3, 3, 3, 4, 3, 3, 3, 3, 3, 3, 3, 3, 1, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 1, 3, });
residualCtxsArray[2].acCtx.initialize({ 6, 6, 3, 5, 5, 4, 2, 4, 4, 3, 3, 3, 3, 3, 2, 4, 4, 4, 4, 4, 4, 3,
3, 3, 3, 3, 3, 3, 3, 3, 2, 4, 3, 4, 4, 3, 3, 3, 3, 3, 3, 3, 3, 3, 3, 3, 3, 3, 3, 3, 3, 3, 3, 3, 3, 3, 3, 3, 3, 3,
3, 3, 2, 3, 6, 6, 3, 5, 4, 4, 2, 5, 4, 4, 3, 3, 3, 3, 2, 4, 4, 4, 3, 3, 3, 3, 3, 3, 3, 3, 3, 3, 3, 3, 2, 4, 4, 3,
3, 3, 3, 3, 3, 3, 3, 3, 3, 3, 3, 3, 3, 3, 3, 3, 3, 3, 3, 3, 3, 3, 3, 3, 3, 3, 3, 3, 2, 3, });
residualCtxsArray[3].acCtx.initialize({ 7, 7, 4, 7, 5, 4, 2, 6, 5, 4, 3, 3, 3, 3, 2, 6, 5, 4, 4, 4, 3, 3,
3, 3, 3, 3, 3, 3, 3, 3, 2, 5, 5, 4, 4, 4, 4, 3, 3, 3, 3, 3, 3, 3, 3, 3, 3, 3, 3, 3, 3, 3, 3, 3, 3, 3, 3, 3, 3, 3,
3, 3, 2, 3, 7, 7, 3, 7, 5, 4, 2, 6, 5, 4, 4, 3, 3, 3, 2, 6, 5, 4, 4, 4, 3, 3, 3, 3, 3, 3, 3, 3, 3, 3, 2, 5, 5, 4,
4, 4, 3, 3, 4, 3, 3, 3, 3, 3, 3, 3, 3, 3, 3, 3, 3, 3, 3, 3, 3, 3, 3, 3, 3, 3, 3, 3, 2, 3, });
residualCtxsArray[4].acCtx.initialize({ 7, 7, 3, 7, 5, 4, 2, 6, 5, 4, 3, 4, 3, 3, 2, 6, 5, 4, 4, 3, 4, 3,
3, 3, 3, 3, 3, 3, 3, 3, 2, 5, 5, 4, 4, 4, 3, 4, 4, 3, 4, 3, 3, 3, 3, 3, 3, 3, 3, 3, 3, 3, 3, 3, 3, 3, 3, 3, 3, 3,
3, 3, 2, 3, 7, 7, 3, 7, 5, 4, 2, 6, 5, 4, 4, 3, 4, 3, 2, 6, 5, 4, 4, 4, 3, 3, 3, 3, 3, 3, 3, 3, 3, 3, 2, 5, 4, 4,
4, 3, 3, 3, 3, 3, 3, 3, 3, 3, 3, 3, 3, 3, 3, 3, 3, 3, 3, 3, 3, 3, 3, 3, 3, 3, 3, 3, 2, 3, });
residualCtxsArray[5].acCtx.initialize({ 6, 6, 3, 6, 3, 3, 3, 5, 4, 3, 3, 3, 3, 3, 3, 5, 4, 3, 3, 3, 3, 3,
3, 3, 3, 3, 3, 3, 3, 3, 3, 4, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 6, 3, 6, 3, 3, 3, 5, 3, 3, 3, 3, 3, 3, 3, 5, 4, 3, 3, 3, 3, 3, 3, 3, 3, 3, 3, 3, 3, 3, 3, 5, 4, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[6].acCtx.initialize({ 5, 5, 3, 5, 3, 3, 3, 5, 3, 3, 3, 3, 3, 3, 3, 5, 4, 3, 3, 3, 3, 3,
3, 3, 3, 3, 3, 3, 3, 3, 3, 4, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 5, 5, 3, 5, 3, 3, 3, 5, 3, 3, 3, 3, 3, 3, 3, 5, 3, 3, 3, 3, 3, 3, 3, 3, 3, 3, 3, 3, 3, 3, 3, 4, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[7].acCtx.initialize({ 6, 6, 3, 6, 3, 4, 3, 5, 4, 3, 3, 3, 3, 3, 3, 5, 4, 3, 3, 3, 3, 3,
3, 3, 3, 3, 3, 3, 3, 3, 3, 4, 4, 4, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 6, 3, 5, 4, 3, 3, 5, 4, 4, 3, 3, 3, 3, 3, 5, 4, 4, 3, 3, 3, 3, 3, 3, 3, 3, 3, 3, 3, 3, 3, 4, 4, 4,
4, 3, 3, 3, 3, 3, 3, 3, 3, 3, 3, 3, 3, 3, 3, 3, 3, 3, 3, 3, 3, 3, 3, 3, 3, 3, 3, 3, 3, 3, });
residualCtxsArray[0].expGolombCtx.initialize({ 3, 3, });
residualCtxsArray[1].expGolombCtx.initialize({ 5, 5, });
residualCtxsArray[2].expGolombCtx.initialize({ 4, 4, });
residualCtxsArray[3].expGolombCtx.initialize({ 4, 5, });
residualCtxsArray[4].expGolombCtx.initialize({ 4, 5, });
residualCtxsArray[5].expGolombCtx.initialize({ 3, 3, });
residualCtxsArray[6].expGolombCtx.initialize({ 3, 3, });
residualCtxsArray[7].expGolombCtx.initialize({ 3, 3, });
residualCtxsArray[0].expGolombOrder.initialize({ 0, 0, });
residualCtxsArray[1].expGolombOrder.initialize({ 0, 0, });
residualCtxsArray[2].expGolombOrder.initialize({ 0, 0, });
residualCtxsArray[3].expGolombOrder.initialize({ 0, 0, });
residualCtxsArray[4].expGolombOrder.initialize({ 0, 0, });
residualCtxsArray[5].expGolombOrder.initialize({ 0, 0, });
residualCtxsArray[6].expGolombOrder.initialize({ 0, 0, });
residualCtxsArray[7].expGolombOrder.initialize({ 0, 0, });
vertexAttributeCountCtxsArray.initialize({ 3, 3, 3, 3, 3, 3, 3, 3, 3, 3, 3, 3, });
attributeIndexIsNewCtxArray.initialize({ 0, });
attributeLocalIndexCtxsArray.initialize({ 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, });
attributeIndexIsSameCtxArray.initialize({ 1, 7, });
attributeIndexCtxArray[0].isZeroCtx.initialize({ 5, });
attributeIndexCtxArray[0].isAbsOneCtx.initialize({ 4, });
attributeIndexCtxArray[0].signCtx.initialize({ 3, });
attributeIndexCtxArray[0].acCtx.initialize({ 4, 4, 2, 4, 3, 3, 2, 4, 3, 3, 3, 3, 3, 3, 2, 3, 3, 3, 3, 3,
3, 3, 3, 3, 3, 3, 3, 3, 3, 3, 2, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 2, 3, });
attributeIndexCtxArray[0].expGolombCtx.initialize({ 3, });
attributeIndexCtxArray[0].expGolombOrder.initialize({ 0, });
};

### Normal Coding:

/* Number of bits: 3
Number of possibilities: 8
Sorted Centroids:
{ 1481, 17511, 27330, 32783, 38100, 44845, 53926, 63554 };
*/
if (nbits == 6) {
singlewayPredictionModeCtxsArray.initialize({ 5, 2, 4, });
multiwayPredictionModeCtxsArray.initialize({ 4, 4, 4, 3, 2, 4, 4, });
predictorCtxsArray.initialize({ 6, 1, 2, 2, 3, 1, 4, 4, 2, 5, 5, 1, 4, 4, 1, 3, 3, 3, 3, 3, 3, 3, 3, 3, });
residualCtxsArray[0].isZeroCtx.initialize({ 5, 5, 3, });
residualCtxsArray[1].isZeroCtx.initialize({ 4, 4, 3, });
residualCtxsArray[2].isZeroCtx.initialize({ 4, 3, 2, });
residualCtxsArray[3].isZeroCtx.initialize({ 5, 4, 3, });
residualCtxsArray[4].isZeroCtx.initialize({ 4, 4, 3, });
residualCtxsArray[5].isZeroCtx.initialize({ 3, 3, 3, });
residualCtxsArray[6].isZeroCtx.initialize({ 3, 3, 3, });
residualCtxsArray[7].isZeroCtx.initialize({ 3, 3, 3, });
residualCtxsArray[0].isAbsOneCtx.initialize({ 4, 4, 1, });
residualCtxsArray[1].isAbsOneCtx.initialize({ 3, 3, 1, });
residualCtxsArray[2].isAbsOneCtx.initialize({ 3, 3, 1, });
residualCtxsArray[3].isAbsOneCtx.initialize({ 2, 2, 0, });
residualCtxsArray[4].isAbsOneCtx.initialize({ 2, 2, 0, });
residualCtxsArray[5].isAbsOneCtx.initialize({ 3, 3, 3, });
residualCtxsArray[6].isAbsOneCtx.initialize({ 3, 3, 3, });
residualCtxsArray[7].isAbsOneCtx.initialize({ 3, 3, 3, });
residualCtxsArray[0].signCtx.initialize({ 2, 2, 1, });
residualCtxsArray[1].signCtx.initialize({ 3, 3, 1, });
residualCtxsArray[2].signCtx.initialize({ 3, 2, 1, });
residualCtxsArray[3].signCtx.initialize({ 3, 2, 0, });
residualCtxsArray[4].signCtx.initialize({ 2, 2, 0, });
residualCtxsArray[5].signCtx.initialize({ 3, 3, 3, });
residualCtxsArray[6].signCtx.initialize({ 3, 3, 3, });
residualCtxsArray[7].signCtx.initialize({ 3, 3, 3, });
residualCtxsArray[0].acCtx.initialize({ 6, 6, 4, 5, 4, 4, 3, 4, 4, 4, 3, 3, 3, 3, 3, 4, 4, 3, 3, 3, 3, 3,
3, 3, 3, 3, 3, 3, 3, 3, 3, 4, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 6, 4, 5, 4, 4, 3, 5, 4, 3, 4, 3, 3, 3, 3, 4, 3, 3, 4, 3, 4, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 4, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[1].acCtx.initialize({ 6, 5, 3, 5, 4, 3, 3, 5, 4, 3, 3, 3, 3, 3, 3, 4, 4, 3, 4, 3, 3, 3,
3, 3, 3, 3, 3, 3, 3, 3, 3, 4, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 5, 3, 5, 4, 3, 3, 5, 4, 3, 3, 3, 3, 3, 3, 4, 4, 3, 3, 3, 3, 3, 3, 3, 3, 3, 3, 3, 3, 3, 3, 4, 4, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[2].acCtx.initialize({ 6, 6, 3, 5, 4, 3, 3, 5, 4, 4, 3, 3, 3, 3, 3, 4, 4, 4, 3, 3, 3, 3,
3, 3, 3, 3, 3, 3, 3, 3, 3, 4, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 6, 6, 3, 5, 4, 3, 3, 5, 4, 4, 3, 3, 3, 3, 3, 4, 4, 4, 3, 3, 3, 3, 3, 3, 3, 3, 3, 3, 3, 3, 3, 4, 3, 4,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[3].acCtx.initialize({ 7, 7, 4, 7, 5, 3, 3, 6, 5, 4, 3, 3, 3, 3, 3, 6, 5, 4, 4, 3, 3, 3,
3, 3, 3, 3, 3, 3, 3, 3, 3, 5, 4, 4, 4, 4, 3, 4, 3, 3, 3, 3, 3, 3, 3, 3, 3, 3, 3, 3, 3, 3, 3, 3, 3, 3, 3, 3, 3, 3,
3, 3, 3, 3, 7, 7, 4, 7, 5, 4, 3, 6, 5, 4, 4, 3, 3, 3, 3, 5, 5, 4, 4, 4, 3, 3, 3, 3, 3, 3, 3, 3, 3, 3, 3, 5, 5, 4,
3, 3, 4, 3, 3, 3, 3, 4, 3, 3, 3, 3, 3, 3, 3, 3, 3, 3, 3, 3, 3, 3, 3, 3, 3, 3, 3, 3, 3, 3, 7, 7, 3, 7, 3, 3, 3, 7,
3, 3, 3, 3, 3, 3, 3, 7, 3, 3, 3, 3, 3, 3, 3, 3, 3, 3, 3, 3, 3, 3, 3, 7, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[4].acCtx.initialize({ 7, 7, 4, 7, 4, 3, 3, 6, 5, 4, 4, 3, 3, 3, 3, 6, 5, 4, 4, 3, 3, 3,
3, 3, 3, 3, 3, 3, 3, 3, 3, 5, 5, 4, 4, 4, 4, 3, 4, 3, 3, 3, 3, 3, 3, 3, 3, 3, 3, 3, 3, 3, 3, 3, 3, 3, 3, 3, 3, 3,
3, 3, 3, 3, 7, 7, 4, 7, 4, 3, 3, 6, 5, 4, 3, 3, 3, 3, 3, 6, 5, 4, 4, 3, 3, 3, 3, 3, 3, 3, 3, 3, 3, 3, 3, 5, 5, 4,
4, 4, 4, 3, 3, 3, 3, 3, 3, 3, 3, 3, 3, 3, 3, 3, 3, 3, 3, 3, 3, 3, 3, 3, 3, 3, 3, 3, 3, 3, 7, 7, 3, 7, 3, 3, 3, 7,
3, 3, 3, 3, 3, 3, 3, 7, 3, 3, 3, 3, 3, 3, 3, 3, 3, 3, 3, 3, 3, 3, 3, 7, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[5].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[6].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[7].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[0].expGolombCtx.initialize({ 3, 3, 3, });
residualCtxsArray[1].expGolombCtx.initialize({ 3, 3, 3, });
residualCtxsArray[2].expGolombCtx.initialize({ 3, 3, 3, });
residualCtxsArray[3].expGolombCtx.initialize({ 3, 3, 3, });
residualCtxsArray[4].expGolombCtx.initialize({ 3, 3, 3, });
residualCtxsArray[5].expGolombCtx.initialize({ 3, 3, 3, });
residualCtxsArray[6].expGolombCtx.initialize({ 3, 3, 3, });
residualCtxsArray[7].expGolombCtx.initialize({ 3, 3, 3, });
residualCtxsArray[0].expGolombOrder.initialize({ 0, 0, 0, });
residualCtxsArray[1].expGolombOrder.initialize({ 0, 0, 0, });
residualCtxsArray[2].expGolombOrder.initialize({ 0, 0, 0, });
residualCtxsArray[3].expGolombOrder.initialize({ 0, 0, 0, });
residualCtxsArray[4].expGolombOrder.initialize({ 0, 0, 0, });
residualCtxsArray[5].expGolombOrder.initialize({ 0, 0, 0, });
residualCtxsArray[6].expGolombOrder.initialize({ 0, 0, 0, });
residualCtxsArray[7].expGolombOrder.initialize({ 0, 0, 0, });
vertexAttributeCountCtxsArray.initialize({ 3, 3, 3, 3, 3, 3, 3, 3, 3, 3, 3, 3, });
attributeIndexIsNewCtxArray.initialize({ 1, });
attributeLocalIndexCtxsArray.initialize({ 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, });
attributeIndexIsSameCtxArray.initialize({ 1, 7, });
attributeIndexCtxArray[0].isZeroCtx.initialize({ 3, });
attributeIndexCtxArray[0].isAbsOneCtx.initialize({ 5, });
attributeIndexCtxArray[0].signCtx.initialize({ 3, });
attributeIndexCtxArray[0].acCtx.initialize({ 3, 5, 1, 5, 4, 3, 1, 5, 4, 3, 3, 3, 3, 3, 1, 5, 4, 4, 3, 3,
3, 3, 3, 3, 3, 3, 3, 3, 3, 3, 0, 4, 3, 3, 3, 2, 3, 3, 3, 3, 3, 3, 3, 3, 3, 3, 3, 3, 3, 4, 3, 3, 3, 3, 3, 3, 3, 3,
3, 3, 3, 3, 0, 3, });
attributeIndexCtxArray[0].expGolombCtx.initialize({ 3, });
attributeIndexCtxArray[0].expGolombOrder.initialize({ 0, });
}else if (nbits == 10) {
singlewayPredictionModeCtxsArray.initialize({ 5, 2, 4, });
multiwayPredictionModeCtxsArray.initialize({ 4, 4, 4, 3, 2, 5, 4, });
predictorCtxsArray.initialize({ 6, 1, 3, 5, 1, 1, 5, 1, 2, 7, 1, 1, 7, 1, 1, 3, 3, 3, 3, 3, 3, 3, 3, 3, });
residualCtxsArray[0].isZeroCtx.initialize({ 5, 5, 3, });
residualCtxsArray[1].isZeroCtx.initialize({ 5, 5, 3, });
residualCtxsArray[2].isZeroCtx.initialize({ 5, 5, 3, });
residualCtxsArray[3].isZeroCtx.initialize({ 6, 6, 4, });
residualCtxsArray[4].isZeroCtx.initialize({ 6, 6, 3, });
residualCtxsArray[5].isZeroCtx.initialize({ 3, 3, 3, });
residualCtxsArray[6].isZeroCtx.initialize({ 3, 3, 3, });
residualCtxsArray[7].isZeroCtx.initialize({ 3, 3, 3, });
residualCtxsArray[0].isAbsOneCtx.initialize({ 4, 4, 1, });
residualCtxsArray[1].isAbsOneCtx.initialize({ 5, 5, 1, });
residualCtxsArray[2].isAbsOneCtx.initialize({ 4, 4, 1, });
residualCtxsArray[3].isAbsOneCtx.initialize({ 6, 6, 0, });
residualCtxsArray[4].isAbsOneCtx.initialize({ 6, 6, 0, });
residualCtxsArray[5].isAbsOneCtx.initialize({ 3, 3, 3, });
residualCtxsArray[6].isAbsOneCtx.initialize({ 3, 3, 3, });
residualCtxsArray[7].isAbsOneCtx.initialize({ 3, 3, 3, });
residualCtxsArray[0].signCtx.initialize({ 2, 2, 1, });
residualCtxsArray[1].signCtx.initialize({ 3, 3, 1, });
residualCtxsArray[2].signCtx.initialize({ 2, 2, 1, });
residualCtxsArray[3].signCtx.initialize({ 3, 2, 0, });
residualCtxsArray[4].signCtx.initialize({ 2, 2, 0, });
residualCtxsArray[5].signCtx.initialize({ 3, 3, 3, });
residualCtxsArray[6].signCtx.initialize({ 3, 3, 3, });
residualCtxsArray[7].signCtx.initialize({ 3, 3, 3, });
residualCtxsArray[0].acCtx.initialize({ 5, 5, 2, 5, 3, 3, 2, 5, 4, 3, 3, 3, 3, 3, 2, 4, 4, 3, 3, 3, 3, 3,
3, 3, 3, 3, 3, 3, 3, 3, 2, 4, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 2, 3, 5, 5, 3, 5, 4, 4, 2, 5, 4, 3, 3, 3, 3, 3, 2, 5, 4, 3, 3, 3, 3, 3, 3, 3, 3, 3, 3, 3, 3, 3, 2, 4, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 2, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[1].acCtx.initialize({ 5, 5, 2, 5, 4, 3, 2, 5, 4, 4, 3, 3, 3, 3, 2, 4, 4, 3, 3, 3, 3, 3,
3, 3, 3, 3, 3, 3, 3, 3, 2, 4, 4, 3, 3, 3, 3, 3, 3, 3, 3, 3, 3, 3, 3, 3, 3, 3, 3, 3, 3, 3, 3, 3, 3, 3, 3, 3, 3, 3,
3, 3, 2, 3, 5, 5, 3, 5, 3, 4, 2, 5, 4, 3, 3, 4, 3, 3, 2, 4, 4, 3, 3, 3, 3, 3, 3, 3, 3, 3, 3, 3, 3, 3, 2, 4, 4, 3,
3, 3, 3, 3, 3, 3, 3, 3, 3, 3, 3, 3, 3, 3, 3, 3, 3, 3, 3, 3, 3, 3, 3, 3, 3, 3, 3, 3, 2, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[2].acCtx.initialize({ 5, 6, 2, 5, 4, 3, 2, 5, 3, 3, 3, 3, 3, 3, 2, 4, 4, 3, 3, 3, 3, 3,
3, 3, 3, 3, 3, 3, 3, 3, 2, 4, 4, 4, 3, 3, 3, 3, 3, 3, 3, 3, 3, 3, 3, 3, 3, 3, 3, 3, 3, 3, 3, 3, 3, 3, 3, 3, 3, 3,
3, 3, 2, 3, 5, 5, 3, 5, 4, 4, 2, 5, 3, 3, 3, 3, 3, 3, 2, 4, 3, 3, 3, 3, 3, 3, 3, 3, 3, 3, 3, 3, 3, 3, 2, 4, 4, 4,
3, 3, 3, 3, 3, 3, 3, 3, 3, 3, 3, 3, 3, 3, 3, 3, 3, 3, 3, 3, 3, 3, 3, 3, 3, 3, 3, 3, 2, 3, 5, 5, 3, 5, 3, 3, 3, 5,
3, 3, 3, 3, 3, 3, 3, 5, 3, 3, 3, 3, 3, 3, 3, 3, 3, 3, 3, 3, 3, 3, 3, 5, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[3].acCtx.initialize({ 6, 6, 3, 6, 4, 4, 1, 5, 4, 4, 4, 4, 3, 3, 1, 5, 4, 3, 3, 4, 4, 3,
4, 3, 3, 3, 3, 3, 3, 3, 1, 4, 3, 4, 3, 3, 3, 4, 3, 3, 3, 3, 3, 3, 3, 3, 3, 3, 3, 3, 3, 3, 3, 3, 3, 3, 3, 3, 3, 3,
3, 3, 1, 3, 7, 6, 2, 6, 5, 4, 1, 5, 4, 4, 4, 4, 4, 4, 1, 5, 4, 4, 3, 3, 3, 4, 3, 3, 4, 3, 3, 3, 3, 3, 1, 4, 4, 4,
3, 4, 3, 3, 3, 3, 3, 3, 3, 3, 3, 3, 3, 3, 3, 3, 3, 3, 3, 3, 3, 3, 3, 3, 3, 3, 3, 3, 1, 3, 7, 7, 2, 7, 3, 3, 2, 7,
3, 3, 3, 3, 3, 3, 2, 7, 3, 3, 3, 3, 3, 3, 3, 3, 3, 3, 3, 3, 3, 3, 2, 7, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 2, 3, });
residualCtxsArray[4].acCtx.initialize({ 6, 6, 3, 6, 5, 4, 2, 5, 5, 4, 4, 3, 3, 3, 1, 5, 4, 4, 4, 4, 4, 3,
3, 3, 3, 3, 3, 3, 4, 3, 1, 5, 4, 4, 3, 4, 3, 4, 4, 3, 4, 3, 3, 3, 3, 3, 3, 3, 3, 3, 3, 3, 3, 3, 3, 3, 3, 3, 3, 3,
3, 3, 0, 3, 6, 6, 3, 6, 5, 4, 1, 5, 5, 4, 4, 4, 4, 3, 1, 5, 4, 4, 4, 3, 3, 3, 3, 3, 3, 4, 3, 3, 3, 3, 1, 4, 4, 4,
3, 4, 4, 4, 3, 3, 3, 3, 4, 4, 3, 3, 3, 4, 3, 3, 3, 3, 3, 3, 3, 3, 3, 3, 3, 3, 3, 3, 0, 3, 7, 7, 2, 7, 3, 3, 2, 7,
3, 3, 3, 3, 3, 3, 2, 7, 3, 3, 3, 3, 3, 3, 3, 3, 3, 3, 3, 3, 3, 3, 2, 7, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 2, 3, });
residualCtxsArray[5].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[6].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[7].acCtx.initialize({ 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, });
residualCtxsArray[0].expGolombCtx.initialize({ 4, 4, 3, });
residualCtxsArray[1].expGolombCtx.initialize({ 4, 4, 3, });
residualCtxsArray[2].expGolombCtx.initialize({ 4, 4, 3, });
residualCtxsArray[3].expGolombCtx.initialize({ 5, 5, 3, });
residualCtxsArray[4].expGolombCtx.initialize({ 6, 6, 3, });
residualCtxsArray[5].expGolombCtx.initialize({ 3, 3, 3, });
residualCtxsArray[6].expGolombCtx.initialize({ 3, 3, 3, });
residualCtxsArray[7].expGolombCtx.initialize({ 3, 3, 3, });
residualCtxsArray[0].expGolombOrder.initialize({ 0, 0, 0, });
residualCtxsArray[1].expGolombOrder.initialize({ 0, 0, 0, });
residualCtxsArray[2].expGolombOrder.initialize({ 0, 0, 0, });
residualCtxsArray[3].expGolombOrder.initialize({ 0, 0, 0, });
residualCtxsArray[4].expGolombOrder.initialize({ 0, 0, 0, });
residualCtxsArray[5].expGolombOrder.initialize({ 0, 0, 0, });
residualCtxsArray[6].expGolombOrder.initialize({ 0, 0, 0, });
residualCtxsArray[7].expGolombOrder.initialize({ 0, 0, 0, });
vertexAttributeCountCtxsArray.initialize({ 3, 3, 3, 3, 3, 3, 3, 3, 3, 3, 3, 3, });
attributeIndexIsNewCtxArray.initialize({ 1, });
attributeLocalIndexCtxsArray.initialize({ 3, 3, 3, 3, 3, 3, 3, 3, 3, 3, 3, 3, 3, 3, 3, 3, 3, 3, 3, 3, 3,
3, 3, 3, 3, 3, 3, 3, 3, 3, 3, 3, 3, 3, 3, 3, 3, 3, 3, 3, 3, 3, 3, 3, 3, 3, 3, 3, 3, 3, });
attributeIndexIsSameCtxArray.initialize({ 1, 7, });
attributeIndexCtxArray[0].isZeroCtx.initialize({ 4, });
attributeIndexCtxArray[0].isAbsOneCtx.initialize({ 5, });
attributeIndexCtxArray[0].signCtx.initialize({ 3, });
attributeIndexCtxArray[0].acCtx.initialize({ 2, 6, 1, 5, 4, 4, 1, 5, 4, 3, 3, 3, 4, 3, 1, 5, 3, 3, 4, 3,
3, 3, 3, 3, 4, 3, 3, 3, 3, 3, 0, 4, 3, 3, 3, 3, 3, 3, 3, 3, 3, 3, 3, 3, 3, 3, 3, 3, 3, 3, 3, 3, 3, 3, 3, 3, 3, 3,
3, 3, 3, 3, 0, 3, });
attributeIndexCtxArray[0].expGolombCtx.initialize({ 3, });
attributeIndexCtxArray[0].expGolombOrder.initialize({ 0, });
}

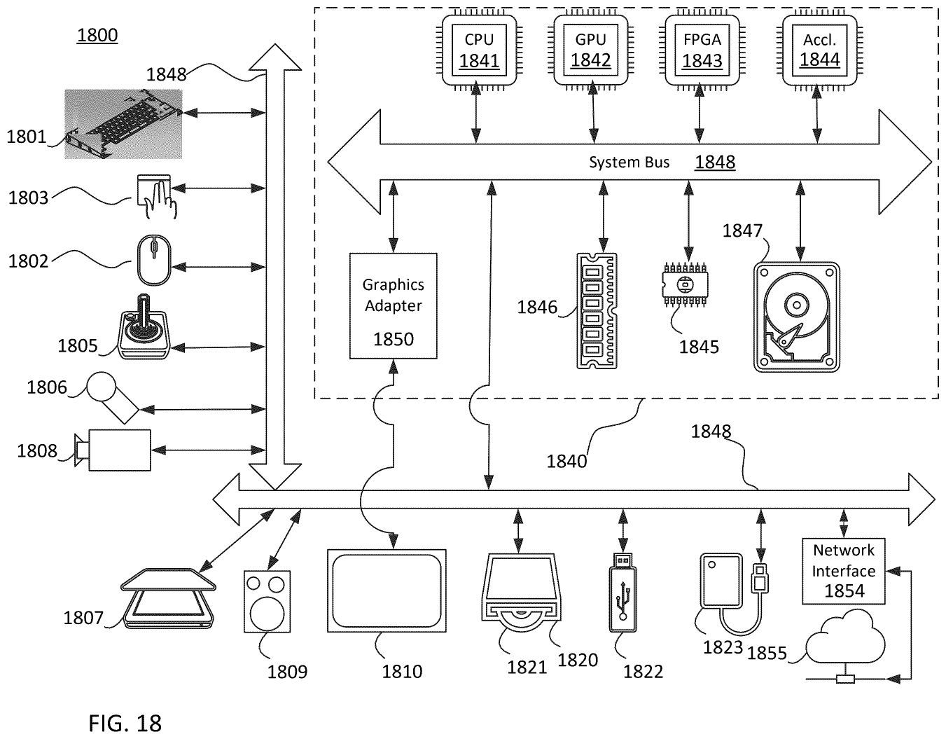

The techniques, described above, may be implemented as computer software using computer-readable instructions and physically stored in one or more computer-readable media. For example, FIG. 18 shows a computer system 1800 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 18 for computer system 1800 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1800.

Computer system 1800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1801, mouse 1802, trackpad 1803, touch screen 1810, data-glove, joystick 1805, microphone 1806, scanner 1807, camera 1808.

Computer system 1800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1810, data glove, or joystick 1805, but there may also be tactile feedback devices that do not serve as input devices). For example, such devices may be audio output devices (such as: speakers 1809, headphones (not depicted)), visual output devices (such as screens 1810 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1800 may also include human accessible storage devices and their associated media such as optical media including CD/DVD ROM/RW 1820 with CD/DVD or the like media 1821, thumb-drive 1822, removable hard drive or solid state drive 1823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1800 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 1849 (such as, for example USB ports of the computer system 1800; others are commonly integrated into the core of the computer system 1800 by attachment to a system bus as described below (for example Ethernet interface into a PC computer system or cellular network interface into a smartphone computer system). Using any of these networks, computer system 1800 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 1855. Certain protocols and protocol stacks may be used on each of those networks and network interfaces as described above.

Aforementioned human interface devices, human-accessible storage devices, and network interfaces 1854 may be attached to a core 1840 of the computer system 1800.

The core 1840 may include one or more Central Processing Units (CPU) 1841, Graphics Processing Units (GPU) 1842, specialized programmable processing units in the form of Field Programmable Gate Areas (FPGA) 1843, hardware accelerators for certain tasks 1844, and so forth. These devices, along with Read-only memory (ROM) 1845, Random-access memory 1846, internal mass storage such as internal non-user accessible hard drives, SSDs, and the like 1847, may be connected through a system bus 1848. In some computer systems, the system bus 1848 may be accessible in the form of one or more physical plugs to enable extensions by additional CPUs, GPU, and the like. The peripheral devices may be attached either directly to the core's system bus 1848, or through a peripheral bus 1849. Architectures for a peripheral bus include PCI, USB, and the like. A graphics adapter 1850 may be included in the core 1840.

CPUs 1841, GPUs 1842, FPGAs 1843, and accelerators 1844 may execute certain instructions that, in combination, may make up the aforementioned computer code. That computer code may be stored in ROM 1845 or RAM 1846. Transitional data may be also be stored in RAM 1846, whereas permanent data may be stored for example, in the internal mass storage 1847. Fast storage and retrieve to any of the memory devices may be enabled through the use of cache memory, that may be closely associated with one or more CPU 1841, GPU 1842, mass storage 1847, ROM 1845, RAM 1846, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 1800, and specifically the core 1840 may provide functionality as a result of processor(s)(including CPUs, GPUs, FPGA, accelerators, and the like) executing software embodied in one or more tangible, computer-readable media. Such computer-readable media may be media associated with user-accessible mass storage as introduced above, as well as certain storage of the core 1840 that are of non-transitory nature, such as core-internal mass storage 1847 or ROM 1845. The software implementing various embodiments of the present disclosure may be stored in such devices and executed by core 1840. A computer-readable medium may include one or more memory devices or chips, according to particular needs. The software may cause the core 1840 and specifically the processors therein (including CPU, GPU, FPGA, and the like) to execute particular processes or particular parts of particular processes described herein, including defining data structures stored in RAM 1846 and modifying such data structures according to the processes defined by the software. In addition or as an alternative, the computer system may provide functionality as a result of logic hardwired or otherwise embodied in a circuit (for example: accelerator 1844), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of encoding performed by at least one processor, the method including: generating a set of N coefficients for a polygon mesh; splitting the set of N coefficients into K coefficient groups, each coefficient group from the K coefficient groups associated with an entropy coding strategy based on one or more properties of the polygon mesh; performing, to generate a set of encoded coefficients, entropy encoding on each coefficient group from the K coefficient groups in accordance with a respective entropy coding strategy; and generating a video bitstream including the set of encoded coefficients, in which N and K are positive integers.

(2) The method according to feature (1), in which a number of groups in the K coefficient groups is determined based on a number of coefficients in the set of N coefficients.

(3) The method according to feature (1) or (2), in which at least one coefficient group of the K coefficient groups is defined by a first threshold and a second threshold less than the first threshold, in which each coefficient from the set of N coefficients having a value that is between the first threshold and the second threshold is assigned to the at least one coefficient group.

(4) The method of feature (3), in which at least one of the first threshold and the second threshold is determined in accordance with a bit depth of the polygon mesh.

(5) The method of feature (4), in which a size of the at least one coefficient group is proportional to the bit depth of the polygon mesh such that the size of the at least one coefficient group increases as the bit depth of the polygon mesh increases.

(6) The method of any one of features (1)-(5), in which a number of groups in the K coefficient groups is determined in accordance with the a bit depth of the polygon mesh.

(7) The method of feature (6), in which the number of groups in the K coefficient groups is proportional to the bit depth of the polygon mesh such that the number of groups increases as the bit depth increases.

(8) The method of any one of features (3)-(7), in which at least one of the first threshold and the second threshold is determined such that an overall group entropy of the K coefficient groups is minimized.

(9) The method of any one of features (3)-(8), in which at least one of the first threshold and the second threshold is determined such that signaling in the video bit stream is minimized.

(10) The method of any one of features (3)-(9), in which at least one of the first threshold and the second threshold is determined in accordance with a previously encoded residual.

(11) The method of any one of features (1)-(10), in which each triangle mesh in the polygon mesh is assigned to a same group, and in which the splitting is performed for each sub-mesh in the polygon mesh having a number of sides greater than 3.

(12) The method of any one of features (1)-(11), in which at least one entropy coding strategy associated with the K coefficient groups is trained using a central mass of a plurality of polygon meshes as an initial probability.

(13) The method of feature (12), in which the at least one entropy coding strategy is associated with a plurality of levels in which a lowest level and a highest level from the plurality of levels are stored, and in which each level between the lowest level and the highest level is interpolated using a distance between the lowest level and the highest level.

(14) A method of decoding performed by at least one processor, the method including: receiving a video bitstream including an encoded polygon mesh; splitting a set of N coefficients of the encoded polygon mesh into K coefficient groups, each coefficient group from the K coefficient groups associated with an entropy decoding strategy based on one or more properties of the polygon mesh; performing, to generate a set of decoded coefficients, entropy decoding on each coefficient group from the K coefficient groups in accordance with a respective entropy decoding strategy; and reconstructing the polygon mesh using the set of decoded coefficients, in which N and K are positive integers.

(15) The method according to feature (14), in which a number of groups in the K coefficient groups is determined based on a number of coefficients in the set of N coefficients.

(16) The method according to feature (14) or (15), in which at least one coefficient group of the K coefficient groups is defined by a first threshold and a second threshold less than the first threshold, in which each coefficient from the set of N coefficients having a value that is between the first threshold and the second threshold is assigned to the at least one coefficient group.

(17) The method of feature (16), in which at least one of the first threshold and the second threshold is determined in accordance with a bit depth of the polygon mesh.

(18) The method of feature (17), in which a size of the at least one coefficient group is proportional to the bit depth of the polygon mesh such that the size of the at least one coefficient group increases as the bit depth of the polygon mesh increases.

(19) The method of any one of features (14)-(18), in which a number of groups in the K coefficient groups is determined in accordance with the a bit depth of the polygon mesh.

(20) A method of performed by at least one processor, the method including: processing a video bitstream including an encoded polygon mesh; in which a set of N coefficients is generated for the polygon mesh, in which the set of N coefficients are split into K coefficient groups, each coefficient group from the K coefficient groups associated with an entropy coding strategy based on one or more properties of the polygon mesh, in which a set of encoded coefficients are generated by performing entropy encoding on each coefficient group from the K coefficient groups in accordance with a respective entropy coding strategy, and in which N and K are positive integers.

What is claimed is:

1. A method of encoding performed by at least one processor, the method comprising:
generating a set of N coefficients for a polygon mesh;
splitting the set of N coefficients into K coefficient groups, each coefficient group from the K coefficient groups associated with an entropy coding strategy based on one or more properties of the polygon mesh;
performing, to generate a set of encoded coefficients, entropy encoding on each coefficient group from the K coefficient groups in accordance with a respective entropy coding strategy; and
generating a video bitstream including the set of encoded coefficients,
wherein N and K are positive integers.

2. The method according to claim 1, wherein a number of groups in the K coefficient groups is determined based on a number of coefficients in the set of N coefficients.

3. The method according to claim 1, wherein at least one coefficient group of the K coefficient groups is defined by a first threshold and a second threshold less than the first threshold, wherein each coefficient from the set of N coefficients having a value that is between the first threshold and the second threshold is assigned to the at least one coefficient group.

4. The method of claim 3, wherein at least one of the first threshold and the second threshold is determined in accordance with a bit depth of the polygon mesh.

5. The method of claim 4, wherein a size of the at least one coefficient group is proportional to the bit depth of the polygon mesh such that the size of the at least one coefficient group increases as the bit depth of the polygon mesh increases.

6. The method of claim 1, wherein a number of groups in the K coefficient groups is determined in accordance with the a bit depth of the polygon mesh.

7. The method of claim 6, wherein the number of groups in the K coefficient groups is proportional to the bit depth of the polygon mesh such that the number of groups increases as the bit depth increases.

8. The method of claim 3, wherein at least one of the first threshold and the second threshold is determined such that an overall group entropy of the K coefficient groups is minimized.

9. The method of claim 3, wherein at least one of the first threshold and the second threshold is determined such that signaling in the video bit stream is minimized.

10. The method of claim 3, wherein at least one of the first threshold and the second threshold is determined in accordance with a previously encoded residual.

11. The method of claim 1, wherein each triangle mesh in the polygon mesh is assigned to a same group, and wherein the splitting is performed for each sub-mesh in the polygon mesh having a number of sides greater than 3.

12. The method according to claim 1, wherein at least one entropy coding strategy associated with the K coefficient groups is trained using a central mass of a plurality of polygon meshes as an initial probability.

13. The method according to claim 12, wherein the at least one entropy coding strategy is associated with a plurality of levels in which a lowest level and a highest level from the plurality of levels are stored, and wherein each level between the lowest level and the highest level is interpolated using a distance between the lowest level and the highest level.

14. A method of decoding performed by at least one processor, the method comprising:
receiving a video bitstream including an encoded polygon mesh;
splitting a set of N coefficients of the encoded polygon mesh into K coefficient groups, each coefficient group from the K coefficient groups associated with an entropy decoding strategy based on one or more properties of the polygon mesh;
performing, to generate a set of decoded coefficients, entropy decoding on each coefficient group from the K coefficient groups in accordance with a respective entropy decoding strategy; and
reconstructing the polygon mesh using the set of decoded coefficients,
wherein N and K are positive integers.

15. The method according to claim 14, wherein a number of groups in the K coefficient groups is determined based on a number of coefficients in the set of N coefficients.

16. The method according to claim 14, wherein at least one coefficient group of the K coefficient groups is defined by a first threshold and a second threshold less than the first threshold, wherein each coefficient from the set of N coefficients having a value that is between the first threshold and the second threshold is assigned to the at least one coefficient group.

17. The method of claim 16, wherein at least one of the first threshold and the second threshold is determined in accordance with a bit depth of the polygon mesh.

18. The method of claim 17, wherein a size of the at least one coefficient group is proportional to the bit depth of the polygon mesh such that the size of the at least one coefficient group increases as the bit depth of the polygon mesh increases.

19. The method of claim 14, wherein a number of groups in the K coefficient groups is determined in accordance with the a bit depth of the polygon mesh.

20. A method of performed by at least one processor, the method comprising:
processing a video bitstream including an encoded polygon mesh;
wherein a set of N coefficients is generated for the polygon mesh,
wherein the set of N coefficients are split into K coefficient groups, each coefficient group from the K coefficient groups associated with an entropy coding strategy based on one or more properties of the polygon mesh,
wherein a set of encoded coefficients are generated by performing entropy encoding on each coefficient group from the K coefficient groups in accordance with a respective entropy coding strategy, and
wherein N and K are positive integers.
